(19) United States
(12) Patent Application Publication
(10) Pub. No.: US 2022/0158305 A1
(43) Pub. Date: May 19, 2022

(54) IMPROVED Z WRAP SEPARATORS, CELLS, SYSTEMS, BATTERIES, AND RELATED EQUIPMENT AND METHODS

(71) Applicant: Daramic, LLC, Charlotte, NC (US)

(72) Inventors: Baiju Parasuraman, Bangalore (IN); Ahila Krishnamoorthy, Bangalore (IN); Naveen Prabhu Shanmugam, Bangalore (IN); Sankara Valli T. Nayagam, Gujarat. (IN); Marimuthu Elangovan, Gujarat. (IN); Santanu Chatterjee, Gujarat (IN)

(21) Appl. No.: 17/423,110

(22) PCT Filed: Jan. 16, 2020
(86) PCT No.: PCT/US2020/013785

§ 371 Date: Jul. 15, 2021

(30) Foreign Application Priority Data
Jan. 16, 2019 (IN) 201911001882

(51) Int. Cl. H01M 50/466; H01M 50/417; H01M 10/12

(52) U.S. Cl. CPC H01M 50/466; H01M 2220/20; H01M 10/125; H01M 50/417

(57) ABSTRACT

New, improved or optimized battery separators, Z wrap separators, Z wrap serrated rib separators, Z wrap serrated rib separators for tubular batteries, components, cells, modules, systems, batteries, tubular batteries, industrial batteries, inverter batteries, batteries for heavy or light industrial applications, forklift batteries, float charged batteries, inverters, accumulators, methods, profiles, additives, compositions, composites, mixes, coatings, and/or related methods of Z wrapping separators, Z wrapping separators on electrodes of tubular batteries, water retention, water loss prevention, improved charge acceptance, production, use, and/or related Z wrapping equipment, and/or combinations thereof. More particularly, the present invention is directed to one or more improved battery separators having various improvements that may result in automated separator Z wrapping, automated Z wrapped cell module production, automated tubular battery production, decreased water loss for a battery in which such a separator is incorporated, enhanced charge acceptance, or combinations thereof. Additionally, the present invention relates to one or more improved battery separators having various improvements with regard to shape, and/or physical profile, and/or chemical(s), additives, mixes, coatings, and/or the like used to make such battery separators (such as oil(s), and/or chemical additive(s) or agents used to coat, finish or improve such battery separators (such as surfactant(s))). Furthermore, the present invention relates to one or more one or more improved separator configurations, Z wrap cell modules, Z wrap tubular electrodes or z wrap gauntlet covered tubular electrodes, and/or battery electrode and separator assembly configurations providing for automation, better acid mixing and/or reduced acid stratification over prior sleeves, pockets, or envelope separator configurations, improved battery electrode and separator assembly configurations and/or manufacturing methods and/or manufacturing equipment. The improved Z wrap battery separators of the instant invention are particularly useful in or with tubular batteries, industrial batteries, such as inverter batteries, batteries for heavy or light industry, and/or the like.

### FIELD

The instant disclosure is directed to new, improved or optimized battery separators, Z wrap separators, Z wrap serrated rib separators, Z wrap serrated rib separators for tubular batteries, components, cells, modules, systems, batteries, tubular batteries, industrial batteries, inverter batteries, batteries for heavy or light industrial applications, forklift batteries, float charged batteries, inverters, accumulators, methods, profiles, additives, compositions, composites, mixes, coatings, and/or related methods of Z wrapping separators, Z wrapping separators on electrodes of tubular batteries, water retention, water loss prevention, improved charge acceptance, production, use, and/or related Z wrapping equipment, and/or combinations thereof. More particularly, the present invention is directed to one or more improved battery separators having various improvements that may result in automated separator Z wrapping, automated Z wrapped cell module production, automated tubular battery production, decreased water loss for a battery in which such a separator is incorporated, enhanced charge acceptance, or combinations thereof. Additionally, the present invention relates to one or more improved battery separators having various improvements with regard to shape, and/or physical profile, and/or chemical(s), additives, mixes, coatings, and/or the like used to make such battery separators (such as oil(s), and/or chemical additive(s) or agents used to coat, finish or improve such battery separators (such as surfactant(s))). Furthermore, the present invention relates to one or more improved separator configurations, Z wrap cell modules, Z wrap tubular electrodes, and/or battery electrode and separator assembly configurations providing for automation, better acid mixing and/or reduced acid stratification over prior sleeves, pockets, or envelope separator configurations. One or more improved battery electrode and separator assembly configurations and/or manufacturing methods and/or manufacturing equipment. The improved Z wrap battery separators of the instant invention are particularly useful in or with tubular batteries, industrial batteries, such as inverter batteries, batteries for heavy or light industry, and so forth.

### BACKGROUND

Various batteries are used in industrial settings and/or settings in which deep discharge is desirable. Such batteries may include, but are not limited to, for example, lead acid batteries, inverter batteries, solar batteries, golf cart batteries, batteries for equipment (such as a floor scrubber or the like), batteries for a forklift or other equipment, submarine batteries, tubular inverter batteries, flat plate inverter batteries, and/or flooded inverter batteries. As is known, discharging deeply means that the battery must provide a lot of energy over a long period of time; therefore, such batteries may begin with a relatively high capacity for energy storage and loose some of its capacity in service over a period of time. Such deep discharge may mean that it may take a relatively long amount of time to fully re-charge such a battery to its full capacity. Thus, improving re-chargeability of such a battery may be important, and obtaining a battery with an improved state of charge or higher partial state of charge may also be important in the battery industry.

For at least certain applications, and charge/discharge cycling applications in particular, it is desirable to provide battery separators far industrial batteries that differentiate from previously known battery separators. A battery separator is a component that divides, or “separates”, the positive electrode from the negative electrode within a battery cell. A battery separator may have two primary functions. First, a battery separator should keep the positive electrode physically apart from the negative electrode in order to prevent any electronic current passing between the two electrodes. Second, a battery separator should permit an ionic current between the positive and negative electrodes with the least possible resistance. A battery separator may be made out of many different materials, but these two opposing functions have been met well by a battery separator being made of a porous nonconductor.

Improving the re-chargeability of industrial batteries (such as, for example, inverter batteries) is desired. As is known, an inverter turns DC into AC and may be helpful in a wide variety of settings, such as areas where a power grid is unstable or has been deteriorated. Batteries such as inverter batteries operate primarily under a partial state of charge. Constantly operating in a partial state of charge may mean that corrosion occurs, and/or battery life is compromised, and/or negative plate sulfation may become a limiting factor in the performance and life of such batteries. Enhancing the re-chargeability of the battery as well as lowering the amount of water loss encountered by the battery are desirable.

Some previously known battery separators, despite having improved features, have not been able to facilitate automation, to increase acid mixing, to reduce acid stratification, and/or to improve the charge acceptance, and therefore, re-chargeability, of the industrial batteries in which they are placed. Thus, a need exists for an improved battery separator for an industrial battery that provides various improvements over known separators. An improved battery separator that meets such needs may result in improvements in battery characteristics, such as improved charge acceptance of the battery, improved re-chargeability of the battery, reduced water loss of the battery, improved charge/discharge cycling efficiency of the battery, and/or extended life of the battery.

### SUMMARY

In accordance with at least selected embodiments, the instant invention or disclosure may address one or more of the above mentioned desires, needs, issues, and/or problems and may provide new, improved or optimized battery separators, Z wrap separators, Z wrap serrated rib separators, Z wrap serrated rib separators for tubular batteries, components, cells, modules, systems, batteries, tubular batteries, industrial batteries, inverter batteries, batteries for heavy or light industrial applications, forklift batteries, float charged batteries, inverters, accumulators, methods, profiles, additives, compositions, composites, mixes, coatings, and/or related methods of Z wrapping separators, Z wrapping separators on electrodes of tubular batteries, water retention, water loss prevention, improved charge acceptance, production, use, and/or related Z wrapping equipment, and/or combinations thereof. More particularly, the present invention is directed to one or more improved battery separators having various improvements that may result in automated separator Z wrapping, automated Z wrapped cell module production, automated tubular battery production, decreased water loss for a battery in which such a separator is incorporated, enhanced charge acceptance, or combinations thereof. Additionally, the present invention relates to one or more improved battery separators having various improvements with regard to shape, and/or physical profile, and/or chemical(s), additives, mixes, coatings, and/or the like used to make such battery separators (such as oil(s), and/or chemical additive(s) or agents used to coat, finish or improve such battery separators (such as surfactant(s))). Furthermore, the present invention relates to one or more improved separator configurations, Z wrap cell modules, Z wrap tubular electrodes, z wrap gauntlet covered tubular electrodes, and/or battery electrode and separator assembly configurations providing for automation, better acid mixing and/or reduced acid stratification over prior sleeves, pockets, or envelope separator configurations. One or more improved battery electrode and separator assembly configurations and/or manufacturing methods and/or manufacturing equipment. The improved Z wrap battery separators of the instant invention are particularly useful in or with tubular batteries, industrial batteries, such as inverter batteries, batteries for heavy or light industry, and so forth.

In accordance with at least certain embodiments, aspects or objects, the instant invention or disclosure may address one or more of the above mentioned desires, needs, issues, and/or problems and may provide new, improved or optimized battery separators, Z wrap separators, Z wrap serrated rib separators, Z wrap serrated rib separators for tubular batteries, components, cells, modules, systems, batteries, tubular batteries, industrial batteries, inverter batteries, batteries for heavy or light industrial applications, forklift batteries, float charged batteries, inverters, accumulators, methods, profiles, additives, compositions, composites, mixes, coatings, and/or related methods of Z wrapping separators, Z wrapping separators on electrodes of tubular batteries, water retention, water loss prevention, improved charge acceptance, production, use, and/or related Z wrapping equipment, and/or battery separators and methods relating to batteries, including, but not limited to, industrial batteries. In at least select embodiments, the battery separator may have an improved physical shape and/or profile and may include an optimized amount of one or more chemical additives, such as one or more surfactants, to provide the improved battery separator with improved properties. Additionally, the present invention relates to one or more improved battery separators having various improvements with regard to shape, and/or physical profile, and/or chemical(s) used to make such battery separators (such as oil), and/or chemical additive(s) used to coat, finish or improve such battery separators (such as surfactants).

The improved battery separators and methods of the present invention may result in improved battery properties for batteries into which such separators are incorporated. Such improved properties include, but are not limited to, increased charge acceptance for the battery in which the separator is used and increased re-chargeability for such battery as well as decreased water loss for such a battery. The improved battery separators of the instant invention are particularly useful with industrial batteries, such as inverter batteries, batteries for heavy or light duty industrial applications, and so forth. In accordance with at least selected embodiments, aspects, or objects, the present invention may address the limitations of the prior art and is directed to new, improved or optimized battery separators, components, batteries, industrial batteries, inverter batteries, batteries for heavy or light industrial applications, forklift batteries, float charged batteries, inverters, accumulators, systems, methods, profiles, additives, compositions, composites, mixes, coatings, and/or related methods of water retention, water loss prevention, improved charge acceptance, production, use, and/or combinations thereof. More particularly, the present invention is directed to one or more improved battery separators having various improvements that may result in decreased water loss for a battery in which such a separator is incorporated, enhanced charge acceptance, or combinations thereof. Additionally, the present invention relates to one or more improved battery separators having various improvements with regard to shape, and/or physical profile, and/or chemical(s), additives, mixes, coatings, and/or the like used to make such battery separators (such as oil(s), and/or chemical additive(s) or agents used to coat, finish or improve such battery separators (such as surfactant(s))). The improved battery separators of the instant invention are particularly useful in or with industrial batteries, such as inverter batteries, batteries for heavy or light duty industrial applications, and so forth.

The details of one or more embodiments are set forth in the description herinafter. Other features, objects, and advantages will be apparent from the description and from the claims. In accordance with at least select embodiments, the present disclosure or invention may address the above issues or needs. In accordance with at least certain embodiments, aspects, or objects, the present disclosure or invention may provide an improved separator and/or battery utilizing said separator which overcomes the aforementioned problems. For instance, by providing batteries having reduced acid starvation; reduced acid stratification; improved separator resiliency; mitigating the formation of dendrites; increased oxidation resistance; reduced water loss; reduced internal resistance; increased separator wettability; improved acid diffusion through the separator; improved cold cranking amps, improved uniformity; and/or having improved cycling performance; and any combination thereof.

In certain preferred embodiments, the present disclosure or invention provides a battery separator whose components and physical attributes and features synergistically combine to address, in unexpected ways, previously unmet needs in the deep cycle battery industry, with an improved battery separator (a separator having a porous, membrane of polymer, such as polyethylene, plus a certain amount of a performance enhancing additive and ribs) that meets or, in certain embodiments, exceeds the performance of the previously known flexible, which are currently used in many deep cycle battery applications. In particular, the inventive separators described herein are more robust, less fragile, less brittle, more stable over time (less susceptible to degradation) than separators traditionally used with deep cycle batteries. The flexible, performance enhancing additive-containing and rib possessing separators of the present invention combine the desired robust physical and mechanical properties of a polyethylene-based separator with the capabilities of a conventional separator, while also enhancing the performance of the battery system employing the same.

In accordance with at least selected embodiments, the present disclosure or invention may address the above issues or needs. In accordance with at least certain objects, the present disclosure or invention may provide an improved separator and/or battery which overcomes the aforementioned problems, for instance by providing for increased automation and/or production of Z wrap separators, cells, cell modules, tubular batteries, inverter batteries, and/or enhanced flooded batteries having reduced acid starvation, reduced acid stratification, reduced dendrite growth, reduced internal electrical resistance and/or increased cold cranking amps.

### BRIEF DESCRIPTION OF THE FIGURES

FIG. 1 is a schematic cross section of an exemplary lead acid battery.

FIGS. 2A-2D include several views of a possibly preferred serrated rib battery separator according to one embodiment of the present invention. FIG. 2A is a top plan view of the positive side of such battery separator (i.e., the side that faces the positive electrode of a battery). FIG. 2B is a side edge view along an axis generally parallel to a machine direction and of the separator. FIG. 2C (view F) is a side edge view along an axis generally parallel to a cross-machine direction (cmd) of the separator. FIG. 2D is an enlarged view of that depicted in FIG. 2B.

FIG. 2E is a top plan view of a particular embodiment of a possibly preferred broken, angled rib battery separator according to another embodiment of the present invention or disclosure having a plurality of acid mixing, angled positive ribs.

FIGS. 3A and 3B illustrates respective inventive exemplary serrated rib Z wrap separator and electrode assemblies (or cell, or cell module, or system) exhibiting a “Z” shaped separator wrap.

FIGS. 4A-4F illustrate various points in an exemplary inventive automated manufacturing process of a separator and electrode assembly as generally shown in FIGS. 3A, 3B and 4F.

FIG. 5 is a graph of average water loss of three designs over 42 days. The designs include batteries with standard industrial PE separator and batteries with two separate embodiments of one profile of the present invention. The average water loss was calculated every 21 days, and totaled at the end of the test.

FIG. 6 is a graph of average water loss of two separate designs over 84 days. The designs include batteries with standard industrial PE separator and batteries with separators according to an embodiment of the profile of the present invention. The average water loss was calculated every 21 days, and totaled at the end of the test.

FIG. 7 includes a graph of the float current over the first 21 days of testing three batteries (shown as Sample #1) employing various separators described in the Examples.

FIG. 8 includes a graph of the float current over the second 21 days of testing three batteries (shown as Sample #1) employing various separators described in the Examples.

FIG. 9 includes a graph of the float current over the first 21 days of testing three batteries (shown as Sample #2) employing various separators described in the Examples.

FIG. 10 includes a graph of the float current over the second 21 days of testing three batteries (shown as Sample #2) employing various separators described in the Examples.

FIG. 11 includes a graph of the float current over the first 21 days of testing three batteries (shown as Sample #3) employing various separators described in the Examples.

FIG. 12 includes a graph of the float current over the second 21 days of testing three batteries (shown as Sample #3) employing various separators described in the Examples.

FIG. 13 includes a graph showing the backup time for batteries (shown as Sample #1) employing three different separators described in the Examples.

FIG. 14 includes a graph showing the backup time for batteries (shown as Sample #2) employing two different separators described in the Examples.

FIG. 15 includes a graph showing specific gravity trends for the electrolyte inside batteries (shown as Sample #1) employing three different separators described in the Examples.

FIG. 16 includes a graph showing specific gravity trends for the electrolyte inside batteries (shown as Sample #2) employing two different separators described in the Examples.

FIG. 17 includes a graph showing the end charge current over a number of cycles for batteries (shown as Sample #1) employing three different separators described in the Examples.

FIG. 18 includes a graph showing the end charge current over a number of cycles for batteries (shown as Sample #2) employing two different separators described in the Examples.

FIGS. 19A-19D include four graphs showing charging current versus time for batteries (shown as Sample #1) after given numbers of cycles and employing two different separators described in the Examples.

FIGS. 20A-20D include four graphs showing charging current versus time for batteries (shown as Sample #2) after given numbers of cycles and employing two different separators described in the Examples.

FIG. 21A is a schematic rendering of an elongation test sample. FIG. 21B illustrates a sample holder for an elongation test.

### DETAILED DESCRIPTION

In accordance with at least select embodiments, the present disclosure or invention may address the above issues or needs. In accordance with at least certain objects, aspects, or embodiments, the present disclosure or invention may provide an improved separator and/or battery which overcomes the aforementioned problems, for instance by providing batteries with separators that reduce acid starvation and/or mitigate the effects of acid starvation.

In accordance with at least select embodiments, the present disclosure or invention is directed to novel or improved separators, cells, batteries, systems, and/or methods of manufacture and/or use of such novel separators, cells, and/or batteries. In accordance with at least certain embodiments, the present disclosure or invention is directed to novel or improved battery separators for flat-plate batteries, tubular batteries, flooded lead acid batteries, enhanced flooded lead acid batteries (“EFBs”), deep-cycle batteries, gel batteries, absorptive glass mat (“AGM”) batteries, inverter batteries, solar or wind power storage batteries, vehicle batteries, starting-lighting-ignition (“SLI”) vehicle batteries, idling-start-stop (“ISS”) vehicle batteries, automobile batteries, truck batteries, motorcycle batteries, all-terrain vehicle batteries, forklift batteries, golf cart batteries, hybrid-electric vehicle batteries, electric vehicle batteries, e-rickshaw batteries, e-bike batteries, and/or improved methods of making and/or using such improved separators, cells, batteries, systems, and/or the like. In addition, disclosed herein are methods, systems and battery separators for enhancing battery performance and life, reducing battery failure, reducing acid stratification, mitigating dendrite formation, improving oxidation stability, improving, maintaining, and/or lowering float current, improving end of charge current, decreasing the current and/or voltage needed to charge and/or fully charge a deep cycle battery, reducing internal electrical resistance, reducing antimony poisoning, increasing wettability, improving acid diffusion, improving uniformity in a lead acid battery, and/or improving cycle performance. In accordance with at least particular embodiments, the present disclosure or invention is directed to an improved separator wherein the novel separator includes decreased electrical resistance, performance enhancing additives or coatings, improved fillers, increased wettability, increased acid diffusion, negative cross ribs, and/or the like.

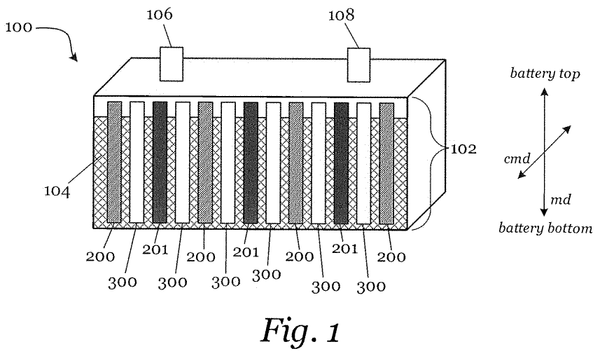

Referring now to FIG. 1, an exemplary lead acid battery 100 is provided with a separator and electrode array 102 having alternating positive electrodes 200 and negative electrodes 201, and a separator 300 interleafed between each positive electrode 200 and negative electrode 201. The electrodes 200, 201 and separators 300 are substantially submerged in a sulfuric acid (H₂SO₄) electrolyte 104. The positive electrodes 200 are in electrical communication with a positive battery terminal 106, and negative electrodes 201 are in electrical communication with the negative battery terminal 108. The battery has a battery top, on which the terminals 106, 108 are disposed and a battery bottom. An axis running substantially orthogonally between the battery top and the battery bottom is the machine direction md axis, and a cross-machine direction (cmd) axis rubs substantially orthogonal to the machine direction md axis.

Physical Description

An exemplary separator may be provided with a web of a porous membrane, such as a microporous membrane having pores less than about 5 μm, preferably less than about 1 μm, a mesoporous membrane, or a macroporous membrane having pores greater than about 1 μm. The porous membrane may preferably have a pore size that is sub-micron up to 100 μm, and in certain embodiments between about 0.1 μm to about 10 μm. Porosity of the separator membrane described herein may be greater than 50% to 60% in certain embodiments. In certain select embodiments, the porous membrane may be flat or possess ribs that extend from a surface thereof.

Ribs

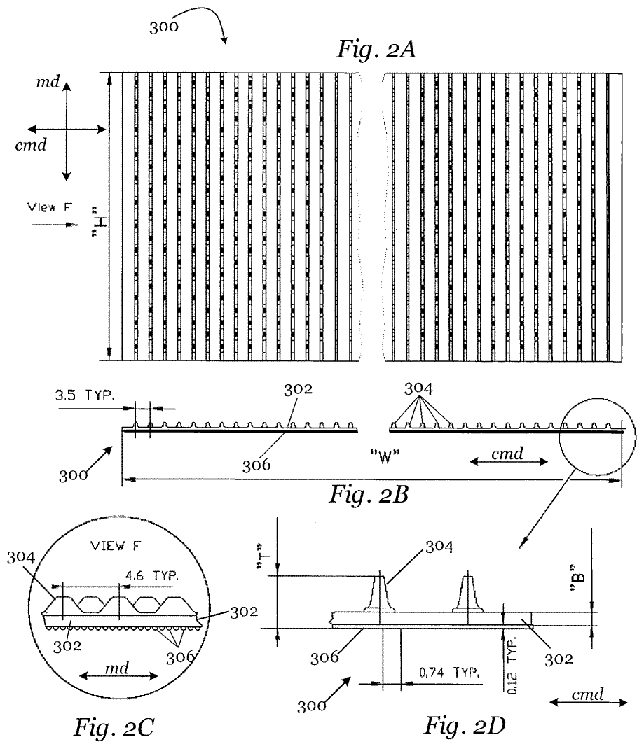

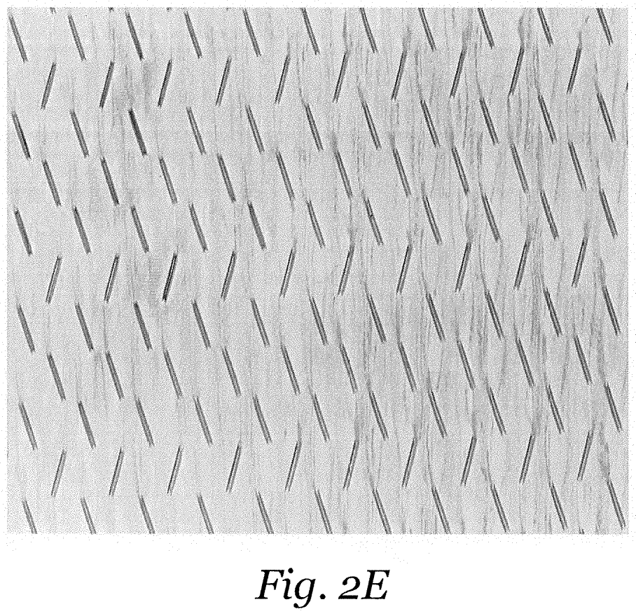

With reference now to FIGS. 2A-2D, an exemplary battery separator 300 is shown. The separator is provided with a porous membrane backweb 302. An array of serrated ribs 304 extend from a first surface of the backweb 302, and an array of mini ribs 306 extend from a second surface of the backweb 302. The serrated ribs 304 may preferably face a positive electrode when disposed within a battery and thusly be referred to as positive ribs. The mini ribs 306 may preferably face a negative electrode when disposed within a battery. In addition to facing a negative electrode, the mini ribs 306 may additionally be disposed in a cross-machine direction and may thusly be referred to as negative cross ribs.

While it is preferred that the positive ribs 304 face a positive electrode and the negative cross ribs 306 face a negative electrode, they may nonetheless be disposed on opposite sides and face the opposite electrode, may have serrated ribs on both sides, and/or the negative cross ribs may be instead disposed in a machine or longitudinal direction.

The positive ribs 304 or negative ribs 306 may additionally be any form or combination of solid ribs, discrete broken ribs, continuous ribs, discontinuous ribs, discontinuous peaks, discontinuous protrusions, angled ribs, linear ribs, longitudinal ribs extending substantially in a machine direction of said porous membrane, lateral ribs extending substantially in a cross-machine direction of said porous membrane, transverse ribs extending substantially in said cross-machine direction of the separator, discrete teeth, toothed ribs, serrations, serrated ribs, battlements, battlemented ribs, curved ribs, sinusoidal ribs, disposed in a continuous zig-zag-sawtooth-like fashion, disposed in a broken discontinuous zig-zag-sawtooth-like fashion, grooves, channels, textured areas, embossments, dimples, columns, mini columns, porous, non-porous, mini ribs, cross-mini ribs, and combinations thereof.

With reference now to FIG. 2E, the positive ribs 304 or negative ribs 306 may additionally be any form or combination of being defined by an angle that is neither parallel nor orthogonal relative to an edge of the separator. Furthermore, that angle may vary throughout the ribs or rows of the ribs. The angled rib pattern may be a possibly preferred Daramic® RipTide™ acid mixing rib profile that can help reduce, eliminate, or mitigate acid stratification in certain batteries. Moreover, the angle may be defined as being relative to a machine direction of the porous membrane and the angle may between approximately greater than zero degrees (0°) and approximately less than 180 degrees (180°), and approximately greater than 180 degrees (180°) and approximately less than 360 degrees (360°). Furthermore, negative cross ribs assist in reducing, mitigating, or preventing acid stratification as well as supporting the negative active material typically found on negative lead acid battery electrodes.

In some select embodiments, at least a portion of the porous membrane may have negative ribs that are longitudinal or transverse or cross-ribs. The negative ribs may be parallel to the top edge of the separator, or may be disposed at an angle thereto. For instance, the negative ribs may be oriented approximately 0°, 5°, 15°, 25°, 30°, 45°, 60°, 70°, 80°, or 90° relative to the top edge. The cross-ribs may be oriented approximately 0° to approximately 30°, approximately 30° to approximately 45°, approximately 45° to approximately 60°, approximately 30° to approximately 60°, approximately 30° to approximately 90°, or approximately 60° to approximately 90° relative to the top edge.

Backweb Thickness In some embodiments, the porous separator membrane can have a backweb thickness from approximately 50 μm to approximately 1.0 mm. for example, the backweb thickness may be may be approximately 50 μm, 100 μm, 150 μm, 200 μm, 300 μm, 400 μm, 500 μm, 600 μm, 700 μm, 800 μm, 900 μm, or 1.0 mm. In other exemplary embodiments, the backweb thickness T_{BACK} may be no greater than approximately 1.0 mm, 900 μm, 800 μm, 700 μm, 600 μm, 500 μm, 400 μm, 300 μm, 200 μm, 100 μm, or 50 μm. In certain preferred embodiments, a backweb thickness may be between approximately 200 μm and approximately 500 μm.

The total thickness of exemplary separators (backweb thickness and the heights of positive and negative ribs) typically range from approximately 250 μm to approximately 4.0 mm. The total thickness of separators used in automotive start/stop batteries are typically approximately 250 μm to approximately 1.0 mm. The total thickness of separators used in industrial traction-type start/stop batteries are typically approximately 1.0 mm to approximately 4.0 mm.

Assembly

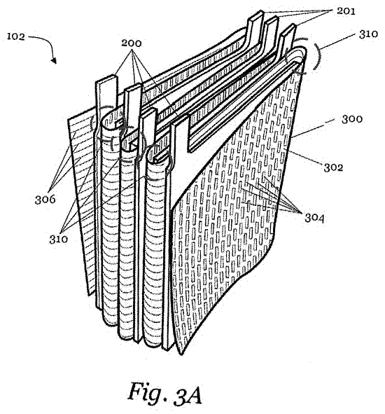

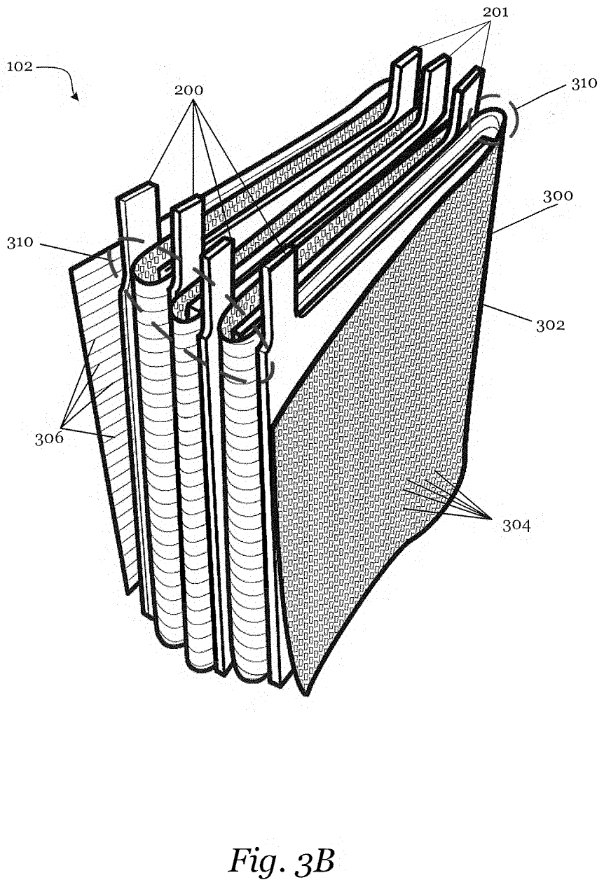

With reference now to FIGS. 3A and 3B, a separator and electrode assembly 102 is shown with different patterns of positive ribs 306 between the two illustrations. As shown, the separator 300 is one continuous piece that is wrapped about and between the electrodes 200, 201 in a Z wrap or z-shaped fashion. The separator 300 has a curved or rounded bend 310 at alternating lateral side edges of the electrodes 200, 201. There are no welds or seams in this embodiment. The bend may have a radius of curvature of up to about 6.0 m or from about 1.8 mm to approximately 6.0 mm. In some embodiments, the bend may have a radius of curvature from approximately 1.0 mm to approximately 6.0 mm, from 2.0 mm to approximately 6.0 mm, from 3.0 mm to approximately 6.0 mm, from approximately 4.0 mm to approximately 6.0 mm, or from approximately 5.0 mm to approximately 6.0 mm. The separator 300 is open at a lateral edge opposite of the bend 310 and at the top and bottom of the electrodes 200, 201. In both embodiments shown in FIGS. 3A and 3B, serrated positive ribs 304 are shown facing the positive electrodes 200, and negative cross ribs 306 are shown facing the negative electrodes 201. Alternatively, an angled rib pattern such as that depicted in FIG. 2E may face the positive electrodes 200, and furthermore may face the negative electrodes 201. However, the preferred embodiment is to have serrated or angled positive ribs 304 face the positive electrodes 200 and negative cross ribs (NCR) or negative cross mini-ribs 306 face the negative electrodes 201.

With respect to tubular batteries, the radius of curvature of the separator matches well with the radius of the tubular electrodes or gauntlet covered tubular electrodes, and the spacing of the serrations is selected such that the backweb is less likely to come into contact with the tubular electrode or gauntlet covered tubular electrodes and oxidize. Having the top, bottom, and one edge open, the Z wrap allows for better electrolyte flow around the electrodes, enhances acid mixing, reduces acid stratification, increases filling speeds, increases cycle life, and/or the like.

In some embodiments two bottom edges of a z wrapped membrane that are facing one another may be sealed or partially sealed. Preferably, the two bottom edges (edges closest to the bottom of the battery) of the z wrapped membrane are on either side of an electrode. In some embodiments, all sets of edges that face each other may be sealed or partially sealed. For example, they may be sealed by at least one of the following means: stapling, gluing, or heat sealing. Partial sealing and stapling may be preferred as the flow of electrolyte is not so hindered. Also, sealing of the minimum number of edges needed to get the desired effect may be preferred so as to allow maximum movement of electrolyte. Sealing or partially sealing the bottom edges pf the z wrapped membrane may help to prevent floating up of the separator during battery operation. The seal will bump into an electrode preventing further movement upward.

In addition, negative cross ribs add some rigidity across the bend and prevent the separator from creasing, which may lead to punctures that result in early failures due to shorts.

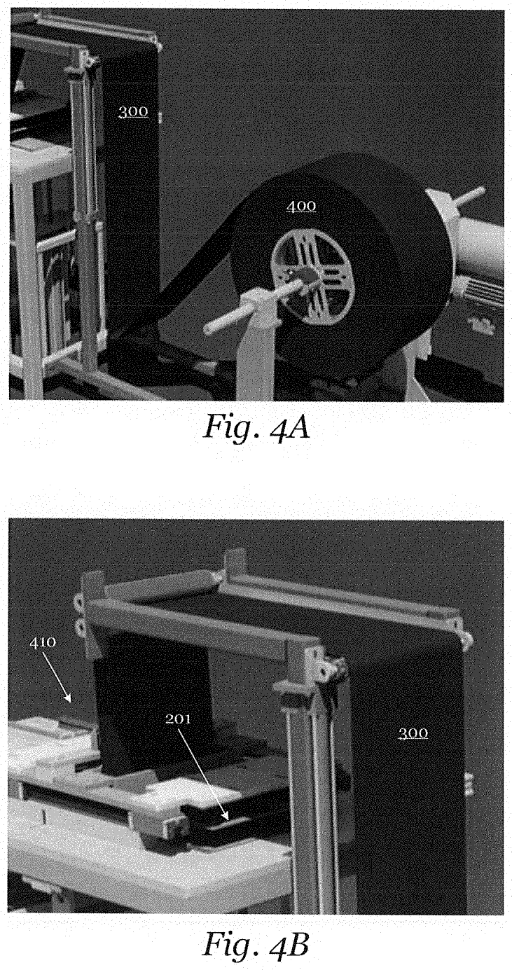

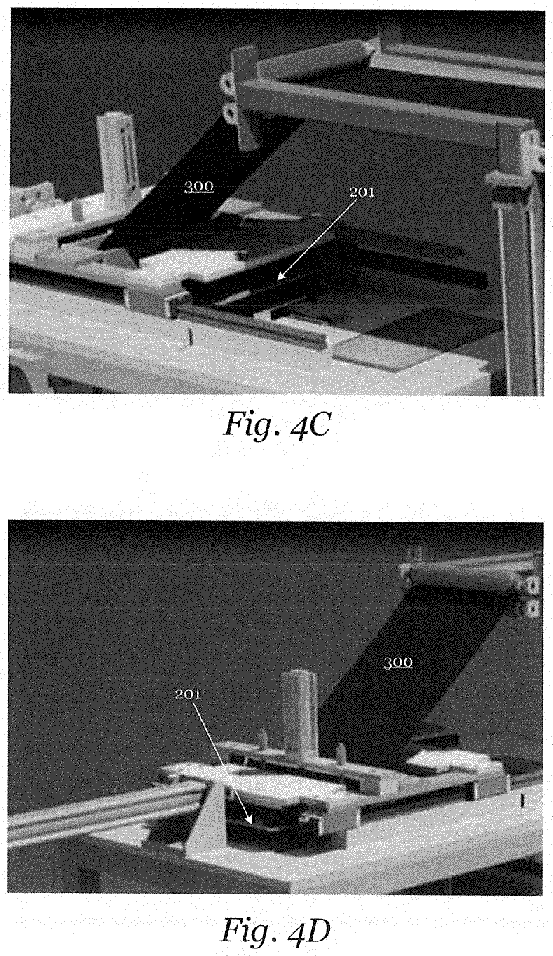

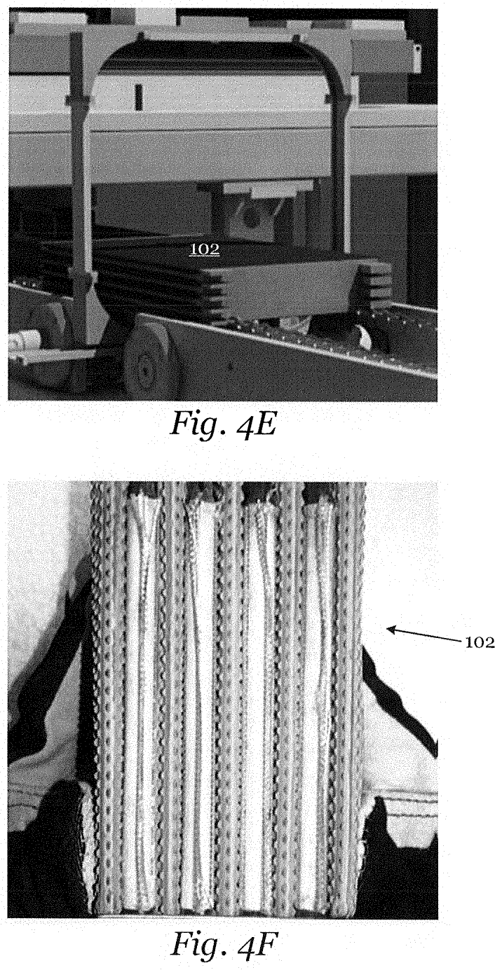

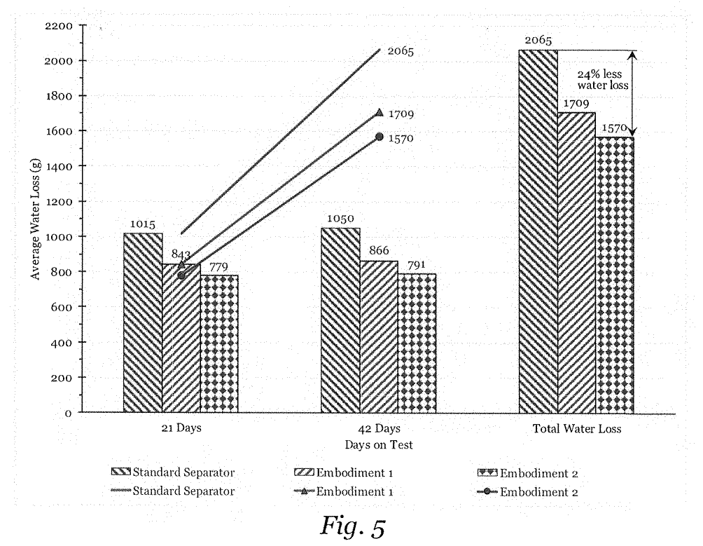

With reference now to FIGS. 4A-4F, an exemplary automated manufacturing process is illustrated for making separator and electrode assemblies as generally described in FIGS. 3A, 3B and 4F.

First a separator web 300 is manufactured as a roll 400 (described hereinafter), and is fed into an assembler 410. The assembler picks a negative plate 201 on a first side of the web 300 and shuttles it into the web 300 and half wraps the negative electrode 201. The assembler then picks a positive electrode 200 on an opposite side of the web 300 and shuttles it into the web 300 and half wraps it.

Composition

In certain embodiments, the improved separator may include a porous membrane may be made of: a natural or synthetic base material; a processing plasticizer; a filler; natural or synthetic rubber(s) or latex, and one or more other additives and/or coatings, and/or the like.

Base Materials

In certain embodiments, exemplary natural or synthetic base materials may include: polymers; thermoplastic polymers; phenolic resins; natural or synthetic rubbers; synthetic wood pulp; lignins; glass fibers; synthetic fibers; cellulosic fibers; and any combination thereof. In certain preferable embodiments, an exemplary separator may be a porous membrane made from thermoplastic polymers. Exemplary thermoplastic polymers may, in principle, include all acid-resistant thermoplastic materials suitable for use in lead acid batteries. In certain preferred embodiments, exemplary thermoplastic polymers may include polyvinyls and polyolefins. In certain embodiments, the polyvinyls may include, for example, polyvinyl chloride (“PVC”). In certain preferred embodiments, the polyolefins may include, for example, polyethylene, polypropylene, ethylene-butene copolymer, and any combination thereof, but preferably polyethylene. In certain embodiments, exemplary natural or synthetic rubbers may include, for example, latex, uncross-linked or cross-linked rubbers, crumb or ground rubber, and any combination thereof.

Polyolefins

In certain embodiments, the porous membrane layer preferably includes a polyolefin, specifically polyethylene. Preferably, the polyethylene is high molecular weight polyethylene (“HMWPE”), (e.g., polyethylene having a molecular weight of at least 600,000). Even more preferably, the polyethylene is ultra-high molecular weight polyethylene (“UHMWPE”). Exemplary UHMWPE may have a molecular weight of at least 1,000,000, in particular more than 4,000,000, and most preferably 5,000,000 to 8,000,000 as measured by viscosimetry and calculated by Margolie's equation. Further, exemplary UHMWPE may possess a standard load melt index of substantially zero (0) as measured as specified in ASTM D 1238 (Condition E) using a standard load of 2,160 g. Moreover, exemplary UHMWPE may have a viscosity number of not less than 600 ml/g, preferably not less than 1,000 ml/g, more preferably not less than 2,000 ml/g, and most preferably not less than 3,000 ml/g, as determined in a solution of 0.02 g of polyolefin in 100 g of decalin at 130° C.

Rubber

The novel separator disclosed herein may contain latex and/or rubber. As used herein, rubber shall describe, rubber, latex, natural rubber, synthetic rubber, cross-linked or uncross-linked rubbers, cured or uncured rubber, crumb or ground rubber, or mixtures thereof. Exemplary natural rubbers may include one or more blends of polyisoprenes, which are commercially available from a variety of suppliers. Exemplary synthetic rubbers include methyl rubber, polybutadiene, chloropene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber and silicone rubber and copolymer rubbers, such as styrene/butadiene rubbers, acrylonitrile/butadiene rubbers, ethylene/propylene rubbers (“EPM” and “EPDM”) and ethylene/vinyl acetate rubbers. The rubber may be a cross-linked rubber or an uncross-linked rubber; in certain preferred embodiments, the rubber is uncross-linked rubber. In certain embodiments, the rubber may be a blend of cross-linked and uncross-linked rubber.

Plasticizer

In certain embodiments, exemplary processing plasticizers may include processing oil, petroleum oil, paraffin-based mineral oil, mineral oil, and any combination thereof.

Fillers

The separator can contain a filler having a high structural morphology. Exemplary fillers can include: silica, dry finely divided silica; precipitated silica; amorphous silica; highly friable silica; alumina; talc; fish meal; fish bone meal; carbon; carbon black; and the like, and combinations thereof. In certain preferred embodiments, the filler is one or more silicas. High structural morphology refers to increased surface area. The filler can have a high surface area, for instance, greater than 100 m²/g, 110 m²/g, 120 m²/g, 130 m²/g, 140 m²/g, 150 m²/g, 160 m²/g, 170 m²/g, 180 m²/g, 190 m²/g, 200 m²/g, 210 m²/g, 220 m²/g, 230 m²/g, 240 m²/g, or 250 m²/g. In some embodiments, the filler (e.g., silica) can have a surface area from about 100 m²/g to about 300 m²/g, about 125 m²/g to about 275 m²/g, 150 m²/g to about 250 m²/g, or preferably 170 m²/g to about 220 m²/g. Surface area can be assessed using TriStar 3000™ for multipoint BET nitrogen surface area. High structural morphology permits the filler to hold more oil during the manufacturing process. For instance, a filler with high structural morphology has a high level of oil absorption, for instance, greater than about 150 ml/100 g, 175 ml/100 g, 200 ml/100 g, 225 ml/100 g, 250 ml/100 g, 275 ml/100 g, 300 ml/100 g, 325 ml/100 g, or 350 ml/100 g. In some embodiments the filler (e.g., silica) can have an oil absorption from 200-500 ml/100 g, 200-400 ml/100 g, 225-375 ml/100 g, 225-350 ml/100 g, 225-325 ml/100 g, preferably 250-300 ml/100 g. In some instances, a silica filler is used having an oil absorption of 266 ml/100 g. Such a silica filler has a moisture content of 5.1%, a BET surface area of 178 m²/g, an average particle size of 23 μm, a sieve residue 230 mesh value of 0.1%, and a bulk density of 135 g/L.

In some select embodiments, the filler (e.g., silica) has an average particle size no greater than 25 μm, in some instances, no greater than 22 μm, 20 μm, 18 μm, 15 μm, or 10 μm. In some instances, the average particle size of the filler particles is 15-25 μm.

The particle size of the silica filler and/or the surface area of the silica filler contributes to the oil absorption of the silica filler. Silica particles in the final product or separator may fall within the sizes described above. However, the initial silica used as raw material may come as one or more agglomerates and/or aggregates and may have sizes around 200 μm or more.

In some preferred embodiments, the silica used to make the inventive separators has an increased amount of or number of surface silanol groups (surface hydroxyl groups) compared with silica fillers used previously to make lead acid battery separators. For example, the silica fillers that may be used with certain preferred embodiments herein may be those silica fillers having at least 10%, at least 15%, at least 20%, at least 25%, at least 30%, or at least 35% more silanol and/or hydroxyl surface groups compared with known silica fillers used to make known polyolefin lead acid battery separators. The ratio (Si—OH)/Si of silanol groups (Si—OH) to elemental silicon (Si) can be measured, for example, as follows.

1. Freeze-crush a polyolefin porous membrane (where certain inventive membranes contain a certain variety of oil-absorbing silica according to the present invention), and prepare the powder-like sample for the solid-state nuclear magnetic resonance spectroscopy (²⁹Si-NMR).

2. Perform the ²⁹Si-NMR to the powder-like sample, and observe the spectrums including the Si spectrum strength which is directly bonding to a hydroxyl group (Spectrum: Q₂ and Q₃) and the Si spectrum strength which is only directly bonding to an oxygen atom (Spectrum: Q₄), wherein the molecular structure of each NMR peak spectrum can be delineated as follows:
Q₂: (SIO)₂—Si*—(OH)₂: having two hydroxyl groups
Q₃: (SiO)₃—Si*—(OH): having one hydroxyl group
Q₄: (SiO)₄—Si*: All Si bondings are SiO

Where Si* is proved element by NMR observation.

3. The conditions for ²⁹Si-NMR used for observation are as follows:
Instrument: Bruker BioSpin Avance 500
Resonance Frequency: 99.36 MHz
Sample amount: 250 mg
NMR Tube: 7 mφ
Observing Method: DD/MAS
Pulse Width: 45°
Repetition time: 100 sec
Scans: 800
Magic Angle Spinning: 5,000 Hz
Chemical Shift Reference: Silicone Rubber as −22.43 ppm

4. Numerically, separate peaks of the spectrum, and calculate the area ratio of each peak belonging to Q₂, Q₃, and Q₄. After that, based on the ratios, calculate the molar ratio of hydroxyl groups (—OH) bonding directly to Si. The conditions for the numerical peak separation is conducted in the following manner:
Fitting region: −80 to −130 ppm
Initial peak top: −93 ppm for Q₂, −101 ppm for Q₃, −111 ppm for Q₄, respectively.
Initial full width half maximum: 400 Hz for Q₂, 350 Hz for Q₃, 450 Hz for Q₄, respectively.
Gaussian function ratio: 80% at initial and 70 to 100% while fitting.

5. The peak area ratios (Total is 100) of Q₂, Q₃, and Q₄ are calculated based on each peak obtained by fitting. The NMR peak area corresponded to the molecular number of each silicate bonding structure (thus, for the Q₄ NMR peak, four Si—O—Si bonds are present within that silicate structure; for the Q₃ NMR peak, three Si—O—Si bonds are present within that silicate structure while one Si—OH bond is present; and for the Q₂ NMR peak, two Si—O—Si bonds are present within that silicate structure while two Si—OH bonds are present). Therefore, each number of the hydroxyl group (—OH) of Q₂, Q₃, and Q₄ is multiplied by two (2) one (1), and zero (0), respectively. These three results are summed. The summed value displays the mole ratio of hydroxyl groups (—OH) directly bonding to Si.

In certain embodiments, the silica may have a molecular ratio of OH to Si groups, measured by ²⁹Si-NMR, that may be within a range of approximately 21:100 to 35:100, in some preferred embodiments approximately 23:100 to approximately 31:100, in certain preferred embodiments, approximately 25:100 to approximately 29:100, and in other preferred embodiments at least approximately 27:100 or greater.

In some select embodiments, use of the fillers described above permits the use of a greater proportion of processing oil during the extrusion step. As the porous structure in the separator is formed, in part, by removal of the oil after the extrusion, higher initial absorbed amounts of oil results in higher porosity or higher void volume. While processing oil is an integral component of the extrusion step, oil is a non-conducting component of the separator. Residual oil in the separator protects the separator from oxidation when in contact with the positive electrode. The precise amount of oil in the processing step may be controlled in the manufacture of conventional separators. Generally speaking, conventional separators are manufactured using 50-70% processing oil, in some embodiments, 55-65%, in some embodiments, 60-65%, and in some embodiments, about 62% by weight processing oil. Reducing oil below about 59% is known to cause burning due to increased friction against the extruder components. However, increasing oil much above the prescribed amount may cause shrinking during the drying stage, leading to dimensional instability. Although previous attempts to increase oil content resulted in pore shrinkage or condensation during the oil removal, separators prepared as disclosed herein exhibit minimal, if any, shrinkage and condensation during oil removal. Thus, porosity can be increased without compromising pore size and dimensional stability, thereby decreasing electrical resistance.

In certain select embodiments, the use of the filler described above allows for a reduced final oil concentration in the finished separator. Since oil is a non-conductor, reducing oil content can increase the ionic conductivity of the separator and assist in lowering the ER of the separator. As such, separators having reduced final oil contents can have increased efficiency. In certain select embodiments are provided separators having a final processing oil content (by weight) less than 20%, for example, between about 14% and 20%, and in some particular embodiments, less than 19%, 18%, 17%, 16%, 15%, 14%, 13%, 12%, 11%, 10%, 9%, 8%, 7%, 6%, or 5%.

The fillers may further reduce what is called the hydration sphere of the electrolyte ions, enhancing their transport across the membrane, thereby once again lowering the overall electrical resistance or ER of the battery, such as an enhanced flooded battery or system.

The filler or fillers may contain various species (e.g., polar species, such as metals) that facilitate the flow of electrolyte and ions across the separator. Such also leads to decreased overall electrical resistance as such a separator is used in a flooded battery, such as an enhanced flooded battery.

Electrical Resistance

In certain selected embodiments, the disclosed separators exhibit decreased electrical resistance, for instance, an electrical resistance no greater than about 200 mΩ·cm², 190 mΩ·cm², 180 mΩ·cm², 170 mΩ·cm², or 160 mΩ·cm².

To test a sample separator for ER testing evaluation in accordance with the present invention, it must first be prepared. To do so, a sample separator is preferably submerged in a bath of demineralized water, the water is then brought to a boil and the separator is then removed after 10 minutes in the boiling demineralized water bath. After removal, excess water is shaken off the separator and then placed in a bath of sulfuric acid having a specific gravity of 1.280 at 27° C.±1° C. The separator is soaked in the sulfuric acid bath for 20 minutes. The separator is then ready to be tested for electrical resistance.

Oxidation Stability

In certain select embodiments, exemplary separators may be characterized with an improved and higher oxidation resistance. Oxidation resistance is measured in elongation of sample separator specimens in the cross-machine direction after prolonged exposure to the lead acid battery electrolyte. For instance, exemplary separators may have an elongation at 40 hours of approximately 150% or higher, 200% or higher, 250% or higher, 300% or higher, 350% or higher, 400% or higher, 450% or higher, or 500% or higher. In certain embodiments, exemplary separators may have a preferred oxidation resistance or elongation at 40 hours of approximately 200% or higher.

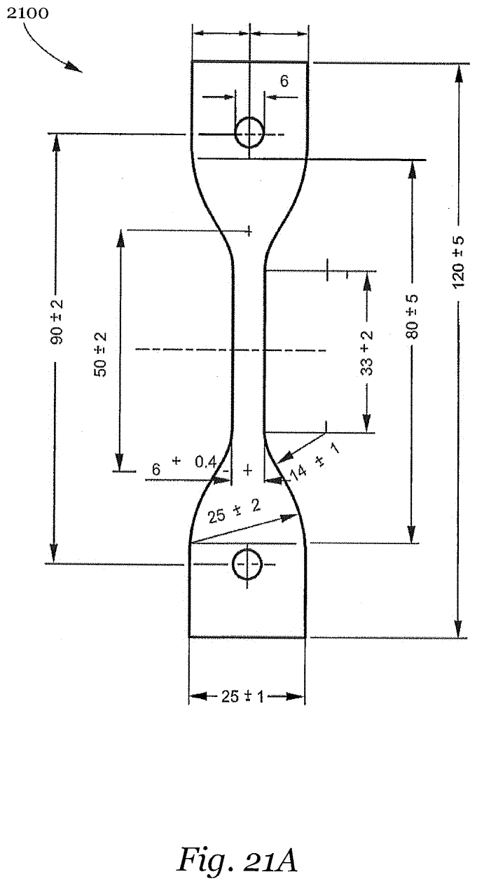

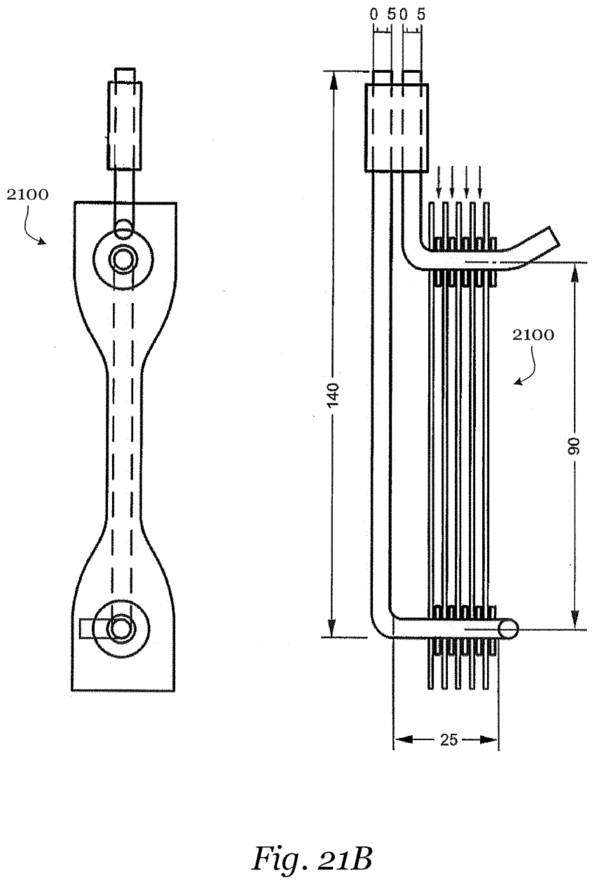

To test samples for oxidation resistance, sample specimens 2100 of exemplary separators are first cut to a shape as generally set forth in FIG. 21A. The specimens 2100 are then placed in a sample holder as generally shown in FIG. 21B.

A first sample set is tested dry, at time=zero (0) hours, for elongation % to break. The elongation is based upon the 50 mm distance as measured from points A and B in FIG. 2-1A. For instance, if points A and B are stretched to a distance of 300%, then the final distance between A and B would be 150 mm.

The elongation test is designed to simulate extended exposure to electrolyte in a cycling battery in a shortened time period. The samples 2100 are first fully submersed in isopropanol, drained and then submersed in water for 1 to 2 seconds. The samples are then submersed in an electrolyte solution. The solution is prepared by adding, in order, 360 ml of 1.28 specific gravity sulfuric acid, 35 ml of 1.84 specific gravity sulfuric acid, then 105 ml of 35% hydrogen peroxide. The solution is kept at 80° C. and the samples are submerged in the solution for an extended period. Samples may be tested for elongation at regular time intervals, such as 20 hours, 40 hours, 60 hours, 80 hours, etc. To test at these intervals, the samples 400 are remove from the 80° C. electrolyte bath and placed under luke-warm running water until the acid has been removed. The elongation can then be tested.

In accordance with at least select embodiments, the present disclosure or invention is directed to improved battery separators, Low ER or high conductance separators, improved lead acid batteries, such as flooded lead acid batteries, high conductance batteries, and/or, improved vehicles including such batteries, and/or methods of manufacture or use of such separators or batteries, and/or combinations thereof. In accordance with at least certain embodiments, the present disclosure or invention is directed to improved lead acid batteries incorporating the improved separators and which exhibit increased conductance.

Additives/Surfactants

In certain embodiments, exemplary separators may contain one or more performance enhancing additives added to the separator or porous membrane. The performance enhancing additive may be surfactants, wetting agents, colorants, antistatic additives, an antimony suppressing additive, UV-protection additives, antioxidants, and/or the like, and any combination thereof. In certain embodiments, the additive surfactants may be ionic, cationic, anionic, or non-ionic surfactants.

In certain embodiments described herein, a reduced amount of anionic or non-ionic surfactant is added to the inventive porous membrane or separator. Because of the lower amount of surfactant, a desirable feature may include lowered total organic carbons (“TOCs”) and/or lowered volatile organic compounds (“VOCs”).

Certain suitable surfactants are non-ionic while other suitable surfactants are anionic. The additive may be a single surfactant or a mixture of two or more surfactants, for instance two or more anionic surfactants, two or more non-ionic surfactants, or at least one ionic surfactant and at least one non-ionic surfactant. Certain suitable surfactants may have HLB values less than 6, preferably less than 3. The use of these certain suitable surfactants in conjunction with the inventive separators described herein can lead to even further improved separators that, when used in a lead acid battery, lead to reduced water loss, reduced antimony poisoning, improved cycling, reduced float current, reduced float potential, and/or the like, or any combination thereof for that lead acid batteries. Suitable surfactants include surfactants such as salts of alkyl sulfates; alkylarylsulfonate salts; alkylphenol-alkylene oxide addition products; soaps; alkyl-naphthalene-sulfonate salts; one or more sulfo-succinates, such as an anionic sulfo-succinate; dialkyl esters of sulfo-succinate salts; amino compounds (primary, secondary, tertiary amines, or quaternary amines); block copolymers of ethylene oxide and propylene oxide; various polyethylene oxides; and salts of mono and dialkyl phosphate esters. The additive can include a non-ionic surfactant such as polyol fatty acid esters, polyethoxylated esters, polyethoxylated alcohols, alkyl polysaccharides such as alkyl polyglycosides and blends thereof, amine ethoxylates, sorbitan fatty acid ester ethoxylates, organosilicone based surfactants, ethylene vinyl acetate terpolymers, ethoxylated alkyl aryl phosphate esters and sucrose esters of fatty acids.

In certain embodiments, the additive may be represented by a compound of Formula (I)

R(OR¹)ₙ(COOM_{1/x}^{x+})ₘ (I)

in which:
R is a linear or non-aromatic hydrocarbon radical with 10 to 4200 carbon atoms, preferably 13 to 4200, which may be interrupted by oxygen atoms;
R¹=H, —(CH₂)ₖCOOM_{1/x}^{x+}; or —(CH₂)ₖ—SO₃M_{1/x}^{x+}, preferably H, where k=1 or 2;
M is an alkali metal or alkaline-earth metal ion, H⁺ or NH₄⁺, where not all the variables M simultaneously have the meaning H⁺;
n=0 or 1;
m=0 or an integer from 10 to 1400; and
x=1 or 2.

The ratio of oxygen atoms to carbon atoms in the compound according to Formula (I) being in the range from 1:1.5 to 1:30 and m and n not being able to simultaneously be 0. However, preferably only one of the variables n and m is different from 0.

By non-aromatic hydrocarbon radicals is meant radicals which contain no aromatic groups or which themselves represent one. The hydrocarbon radicals may be interrupted by oxygen atoms (i.e., contain one or more ether groups).

R is preferably a straight-chain or branched aliphatic hydrocarbon radical which may be interrupted by oxygen atoms. Saturated, uncross-linked hydrocarbon radicals are quite particularly preferred. However, as noted above, R may, in certain embodiments, be aromatic ring-containing.

Through the use of the compounds of Formula (I) for the production of battery separators, they may be effectively protected against oxidative destruction. Battery separators are preferred which contain a compound according to Formula (I) in which:
R is a hydrocarbon radical with 10 to 180, preferably 12 to 75 and quite particularly preferably 14 to 40 carbon atoms, which may be interrupted by 1 to 60, preferably 1 to 20 and quite particularly preferably 1 to 8 oxygen atoms, particularly preferably a hydrocarbon radical of formula R²—[(OC₂H₄)p(OC₃H₆)_{q}]—, in which:
   R² is an alkyl radical with 10 to 30 carbon atoms, preferably 12 to 25, particularly preferably 14 to 20 carbon atoms, wherein R² can be linear or non-linear such as containing an aromatic ring;
   P is an integer from 0 to 30, preferably 0 to 10, particularly preferably 0 to 4; and
   is an integer from 0 to 30, preferably 0 to 10, particularly preferably 0 to 4;
   compounds being particularly preferred in which the sum of p and q is 0 to 10, in particular 0 to 4;
n=1; and
m=0.

Formula R²—[(OC₂H₄)ₚ(OC₃H₆)_{q}]— is to be understood as also including those compounds in which the sequence of the groups in square brackets differs from that shown. For example according to the invention compounds are suitable in which the radical in brackets is formed by alternating (OC₂H₄) and (OC₃H₆) groups.

Additives in which R² is a straight-chain or branched alkyl radical with 10 to 20, preferably 14 to 18 carbon atoms have proved to be particularly advantageous. OC₂H₄ preferably stands for OCH₂CH₂, OC₃H₆ for OCH(CH₃)₂ and/or OCH₂CH₂CH₃.

As preferred additives there may be mentioned in particular alcohols (p=q=0; m=0) primary alcohols being particularly preferred, fatty alcohol ethoxylates (p=1 to 4, q=0), fatty alcohol propoxylates (p=0; q=1 to 4) and fatty alcohol alkoxylates (p=1 to 2; q=1 to 4) ethoxylates of primary alcohols being preferred. The fatty alcohol alkoxylates are for example accessible through reaction of the corresponding alcohols with ethylene oxide or propylene oxide.

Additives of the type m=0 which are not, or only difficulty, soluble in water and sulphuric acid have proved to be particularly advantageous. However, additives that are partially soluble or fully soluble in water, an aqueous solution, or sulfuric acid may also be used. Also preferred are additives which contain a compound according to Formula (I), in which:
R is an alkane radical with 20 to 4200, preferably 50 to 750 and quite particularly preferably 80 to 225 carbon atoms;
M is an alkali metal or alkaline-earth metal ion, H⁺ or NH₄⁺, in particular an alkali metal ion such as Li⁺, Na⁺ and K⁺ or H⁺, where not all the variables M simultaneously have the meaning H⁺;
n=0;
m is an integer from 10 to 1400; and
x=1 or 2.

Salt Additives

In certain embodiments, suitable additives may include, in particular, polyacrylic acids, polymethacrylic acids and acrylic acid-methacrylic acid copolymers, whose acid groups are at least partly neutralized, such as by preferably 40%, and particularly preferably by 80%. The percentage refers to the number of acid groups. Quite particularly preferred are poly(meth)acrylic acids which are present entirely in the salt form. Suitable salts include Li, Na, K, Rb, Be, Mg, Ca, Sr, Zn, and ammonium (NR₄, wherein R is either hydrogen or a carbon functional group). Poly(meth)acrylic acids may include polyacrylic acids, polymethacrylic acids, and acrylic acid-methacrylic acid copolymers. Poly(meth)acrylic acids are preferred and in particular polyacrylic acids with an average molar mass M_{w} of 1,000 to 100,000 g/mol, particularly preferably 1,000 to 15,000 g/mol and quite particularly preferably 1,000 to 4,000 g/mol. The molecular weight of the poly(meth)acrylic acid polymers and copolymers is ascertained by measuring the viscosity of a 1% aqueous solution, neutralized with sodium hydroxide solution, of the polymer (Fikentscher's constant).

Also suitable are copolymers of (meth)acrylic acid, in particular copolymers which, besides (meth)acrylic acid contain ethylene, maleic acid, methyl acrylate, ethyl acrylate, butyl acrylate and/or ethylhexyl acrylate as comonomer. Copolymers are preferred which contain at least 40% by weight and preferably at least 80% by weight (meth)acrylic acid monomer; the percentages being based on the acid form of the monomers or polymers.

To neutralize the polyacrylic acid polymers and copolymers, alkali metal and alkaline-earth metal hydroxides such as potassium hydroxide and in particular sodium hydroxide are particularly suitable. In addition, a coating and/or additive to enhance the separator may include, for example, a metal alkoxide, wherein the metal may be, by way of example only (not intended to be limiting), Zn, Na, or Al, by way of example only, sodium ethoxide.

In some embodiments, the porous polyolefin porous membrane may include a coating on one or both sides of such layer. Such a coating may include a surfactant or other material. In some embodiments, the coating may include one or more materials described, for example, in U.S. Pat. No. 9,876,209, which is incorporated by reference herein. Such a coating may, for example, reduce the overcharge voltage of the battery system, thereby extending battery life with less grid corrosion and preventing dry out and/or water loss.

Ratios

In certain select embodiments, the membrane may be prepared by combining, by weight, about 5-15% polymer, in some instances, about 10% polymer (e.g., polyethylene), about 10-75% filler (e.g., silica), in some instances, about 30% filler, and about 10-85% processing oil, in some instances, about 60% processing oil. In other embodiments, the filler content is reduced, and the oil content is higher, for instance, greater than about 61%, 62%, 63%, 64%, 65%, 66%, 67%, 68%, 69% or 70% by weight. The filler:polymer ratio (by weight) may be about (or may be between about these specific ranges) such as 2:1, 2.5:1, 3:1, 3.5:1, 4.0:1. 4.5:1, 5.0:1, 5.5:1 or 6:1. The filler:polymer ratio (by weight) may be from about 1.5:1 to about 6:1, in some instances, 2:1 to 6:1, from about 2:1 to 5:1, from about 2:1 to 4:1, and in some instances, from about 2:1 to about 3:1. The amounts of the filler, the oil, and polymer are all balanced for runnability and desirable separator properties, such as electrical resistance, basis weight, puncture resistance, bending stiffness, oxidation resistance, porosity, physical strength, tortuosity, and the like.

In accordance with at least one embodiment, the porous membrane can include an UHMWPE mixed with a processing oil and precipitated silica. In accordance with at least one embodiment, the porous membrane can include an UHMWPE mixed with a processing oil, additive and precipitated silica. The mixture may also include minor amounts of other additives or agents as is common in the separator arts (e.g., surfactants, wetting agents, colorants, antistatic additives, antioxidants, and/or the like, and any combination thereof). In certain instances, the porous polymer layer may be a homogeneous mixture of 8 to 100% by volume of polyolefin, 0 to 40% by volume of a plasticizer and 0 to 92% by volume of inert filler material. The preferred plasticizer is petroleum oil. Since the plasticizer is the component which is easiest to remove, by solvent extraction and drying, from the polymer-filler-plasticizer composition, it is useful in imparting porosity to the battery separator.

In certain embodiments, the porous membrane disclosed herein may contain latex and/or rubber, which may be a natural rubber, synthetic rubber, or a mixture thereof. Natural rubbers may include one or more blends of polyisoprenes, which are commercially available from a variety of suppliers. Exemplary synthetic rubbers include methyl rubber, polybutadiene, chloropene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber and silicone rubber and copolymer rubbers, such as styrene/butadiene rubbers, acrylonitrile/butadiene rubbers, ethylene/propylene rubbers (EPM and EPDM) and ethylene/vinyl acetate rubbers. The rubber may be a cross-linked rubber or an uncross-linked rubber; in certain preferred embodiments, the rubber is uncross-linked rubber. In certain embodiments, the rubber may be a blend of cross-linked and uncross-linked rubber. The rubber may be present in the separator in an amount that is at least about 1%, 2%, 3%, 4%, 5%, 6%, 7%, 8%, 9%, or 10% by weight relative to the final separator weight (the weight of the polyolefin separator sheet or layer containing rubber and/or latex). In certain embodiments, the rubber may be present in an amount from approximately 1-6%, approximately 3-6% by weight, approximately 3% by weight, and approximately 6% by weight. The porous membrane may have a filler to polymer and rubber (filler:polymer and rubber) weight ratio of approximately 2.6:1.0. The amounts of the rubber, filler, oil, and polymer are all balanced for runnability and desirable separator properties, such as electrical resistance, basis weight, puncture resistance, bending stiffness, oxidation resistance, porosity, physical strength, tortuosity, and the like. A porous membrane made in accordance with the present invention, comprising polyethylene and filler (e.g., silica) typically has a residual oil content; in some embodiments, such residual oil content is from about 0.5% up to about 40% of the total weight of the separator membrane (in some instances, about 10-40% of the total weight of the separator membrane, and in some instances, about 20-40% of that total weight). In certain select embodiments herein, some to all of the residual oil content in the separator may be replaced by the addition of more of a performance enhancing additive, such as a surfactant, such as a surfactant with a hydrophilic-lipophilic balance (“HLB”) less than 6, or such as a nonionic surfactant. For example, a performance enhancing additive such as a surfactant, such as a nonionic surfactant, may comprise up to 0.5% all the way up to all of the amount of the residual oil content (e.g., all the way up to 20% or 30% or even 40%) of the total weight of the porous separator membrane, thereby partially or completely replacing the residual oil in the separator membrane.

Manufacture

In some embodiments, an exemplary porous membrane may be made by mixing the constituent parts in an extruder. In one non-limiting example, about 30% by weight filler is mixed with about 10% by weight UHMWPE to form a dry blend. This dry blend is then mixed with approximately 60% processing oil may be mixed in an extruder. The exemplary porous membrane may be made by passing the constituent parts through a heated extruder, passing the extrudate generated by the extruder through a die and into a nip formed by two heated presses or a calender stack or rolls to form a continuous web. A substantial amount of the processing oil from the web may be extracted by use of a solvent, thereby followed with removing the solvent by drying. The web may then be cut into lanes of predetermined width, and then wound onto rolls. Additionally, the presses or calender rolls may be engraved with various groove patterns to impart ribs, grooves, textured areas, embossments, and/or the like as substantially described herein. The amounts of the constituent parts are all balanced for runnability and desirable separator properties, such as puncture resistance, backweb thickness, electrical resistance, basis weight, bending stiffness, oxidation resistance, porosity, physical strength, tortuosity, and the like.

In addition, other exemplary embodiments may add various other additives such as natural or synthetic rubbers, performance enhancing additives or agents (e.g., surfactants, wetting agents, colorants, antistatic additives, antioxidants, and/or the like, and any combination thereof) into the constituent parts before forming the extrudate. Alternatively, these additional additives may be applied to the extrudate before or after the processing oil has been extracted, or before or after it has been slit into lanes. Such methods may include forming a slurry to add by dip coat, roller coat, spray coat, or curtain coat one or more surfaces of the separator, or any combination thereof. Furthermore, the additives may be deposited onto the membrane by impregnation and drying.

In certain embodiments, the performance enhancing additive(s) (e.g., a non-ionic surfactant, an anionic surfactant, or mixtures thereof) may be present at a density or add-on level of at least 0.5 g/m², 1.0 g/m², 1.5 g/m², 2.0 g/m², 2.5 g/m², 3.0 g/m², 3.5 g/m², 4.0 g/m², 4.5 g/m², 5.0 g/m², 5.5 g/m², 6.0 g/m², 6.5 g/m², 7.0 g/m², 7.5 g/m², 8.0 g/m², 8.5 g/m², 9.0 g/m², 9.5 g/m² or 10.0 g/m² or even up to about 25.0 g/m². The additive may be present on the separator at a density or add-on level between 0.5-15 g/m², 0.5-10 g/m², 1.0-10.0 g/m², 1.5-10.0 g/m², 2.0-10.0 g/m², 2.5-10.0 g/m², 3.0-10.0 g/m², 3.5-10.0 g/m², 4.0-10.0 g/m², 4.5-10.0 g/m², 5.0-10.0 g/m², 5.5-10.0 g/m², 6.0-10.0 g/m², 6.5-10.0 g/m², 7.0-10.0 g/m², 7.5-10.0 g/m², 4.5-7.5 g/m², 5.0-10.5 g/m², 5.0-11.0 g/m², 5.0-12.0 g/m², 5.0-15.0 g/m², 5.0-16.0 g/m², 5.0-17.0 g/m², 5.0-18.0 g/m², 5.0-19.0 g/m², 5.0-20.0 g/m², 5.0-21.0 g/m², 5.0-22.0 g/m², 5.0-23.0 g/m², 5.0-24.0 g/m², or 5.0-25.0 g/m².

Combined with a Fibrous Mat

In certain embodiments, exemplary separators according to the present disclosure may be combined with another layer (laminated or otherwise), such as a fibrous layer or fibrous mat having enhanced wicking properties and/or enhanced wetting or holding of electrolyte properties. The fibrous mat may be woven, nonwoven, fleeces, mesh, net, single layered, multi-layered (where each layer may have the same, similar or different characteristics than the other layers), composed of glass fibers, or synthetic fibers, fleeces or fabrics made from synthetic fibers or mixtures with glass and synthetic fibers or paper, or any combination thereof.

In certain embodiments, the fibrous mat (laminated or otherwise) may be used as a carrier for additional materials. The addition material may include, for example, rubber and/or latex, optionally silica, water, and/or one or more performance enhancing additive, such as various additives described herein, or any combination thereof. By way of example, the additional material may be delivered in the form of a slurry that may then be coated onto one or more surfaces of the fibrous mat to form a film, or soaked and impregnated into the fibrous mat.

When the fibrous layer is present, it is preferred that the porous membrane has a larger surface area than the fibrous layers. Thus, when combining the porous membrane and the fibrous layers, the fibrous layers do not completely cover the porous layer. It is preferred that at least two opposing edge regions of the membrane layer remain uncovered to provide edges for heat sealing which facilitates the optional formation of pockets or envelopes and/or the like. Such a fibrous mat may have a thickness that is at least 100 μm, in some embodiments, at least about 200 μm, at least about 250 μm, at least about 300 μm, at least about 400 μm, at least about 500 μm, at least about 600 μm, at least about 700 μm, at least about 800 μm, at least about 900 μm, at least about 1 mm, at least about 2 mm, and so forth. The subsequent laminated separator may be cut into pieces. In certain embodiments, the fibrous mat is laminated to a ribbed surface of the porous membrane porous membrane. In certain embodiments, handling and/or assembly advantages are provided to the battery maker with the improved separator described herein, as it may be supplied in roll form and/or cut piece form. And as mentioned previously, the improved separator may be a standalone separator sheet or layer without the addition of one or more fibrous mats or the like.

If the fibrous mat is laminated to the porous membrane, they may be bonded together by adhesive, heat, ultrasonic welding, compression, and/or the like, or any combination thereof. And, the fibrous mat may be a PAM or NAM retention mat.

### EXAMPLES

Various battery separators were made according to the embodiments of the present invention.

### Example 1

In Example 1, a separator was made having a physical profile in accordance with what is shown in FIGS. 2A-2D or 2E. A separator and electrode assembly was thereafter assembled as generally shown in FIG. 3A, 3B or 4F.

### Example 2

In Example 2, several batteries constructed and were tested to determine how well a sleeve type separator with a rib profile according to FIGS. 2A-2D functions. Z wrap serrated rib separators may have even better results. The batteries used were tubular flooded inverter batteries, commercially available from Aegan Batteries located in Bangalore, India. The batteries tested were 12V, 100 Ah at 20 hours. The number of plates per cell was 9 (4 positive and 5 negative). The antimony content in the grids was 2.5%. The mean dry plate weight for the positive plates was 474.5 g, while the mean dry plate weight for the negative plates was 336 g. The positive plate group weight was 1898±2 g/cell; and the negative plate group weight was 1680±1 g/cell.

For the experimental batteries, the separator used was a coated polyethylene separator having a backweb thickness of about 400 μm, an overall thickness of about 1.6 mm, and a serrated profile according to FIGS. 2A-2D. Such experimental separators were coated with a surfactant coating at two add-on levels: embodiment 1 having 4.1 g/m²; and embodiment 2 having 7.4 g/m². For the control batteries, the standard separator used was an uncoated (not coated with the surfactant described herein) polyethylene separator having a backweb thickness of about 450 μm, an overall thickness of about 1.6 mm, and a profile different from the serrated profile seen in FIGS. 2A-2D (specifically, the profile of the control or “comparative” separator included ribs extending diagonally and continuously on the positive side of the separator at about a 10 degree angle from the vertical as well as mini-ribs extending longitudinally and continuously along the negative side of the separator, which mini-ribs were about two times higher in height than the mini-ribs of the experimental battery separators and which mini-ribs were spaced apart about 2-3 times greater than the distance spacing apart the mini-ribs 14 of the experimental battery separators).

Referring now to FIG. 4, batteries were formed using the comparative separator as well as the coated sleeve separator having the serrated profile according to FIGS. 2A to 2D. Z wrap serrated rib separators should have even better results. The batteries were tested over a period of 42 days for water loss. After the first 21 days of testing, the amount of water loss for the coated separator according to the present invention (779.3 g) was much less than the amount of water loss observed for the comparative separator (1014.7 g). The same type of result is shown for the second 21 days of testing. Specifically, the amount of water loss for the coated separator according to the present invention (791.3 g) was much less than the amount of water loss observed for the comparative separator (1050.0 g). The data presented in FIG. 4 shows the highly improved water loss performance of the separator according to the present embodiments having a certain profile (e.g., a serrated profile) and a surfactant coating thereon.

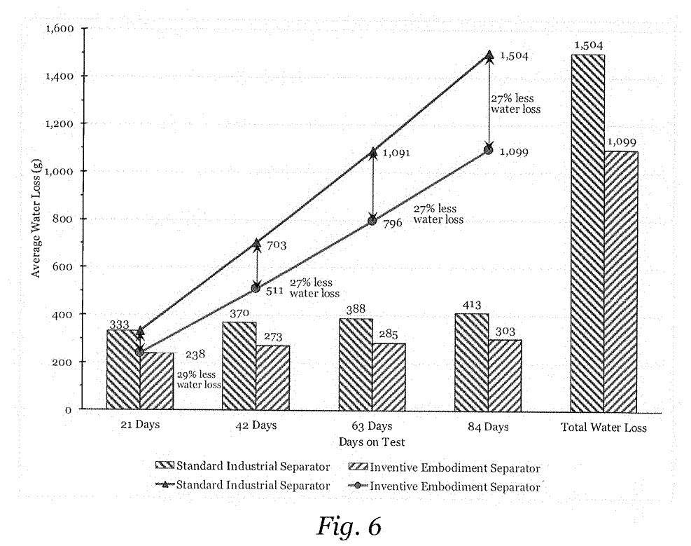

Referring now to FIG. 6, a standard separator that was not coated and an inventive embodiment of the present invention were tested over 84 days at 40° C. in batteries that were industrial tubular batteries being 12V, 180 Ah at 20 hours. Water loss data was measured every 21 days. As shown the inventive separator outperformed the standard separator by losing 27% less water over the life of the test.

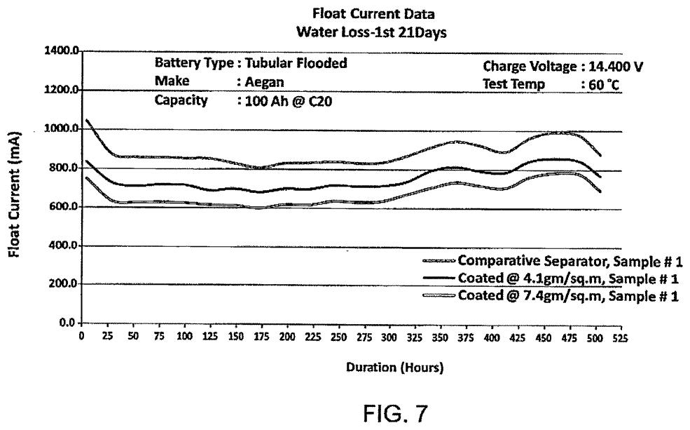

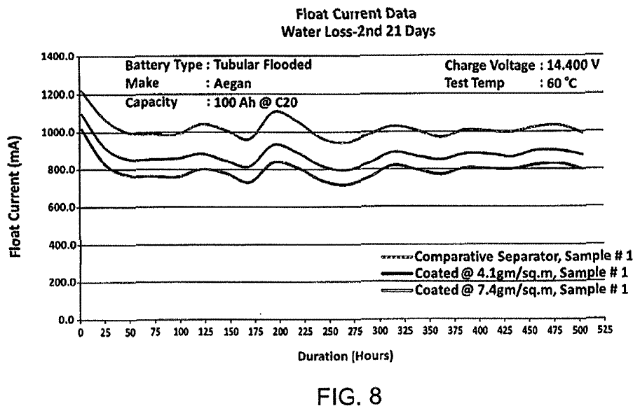

Float current data was also obtained for the batteries and is presented in FIGS. 7-12. As shown in FIG. 7, the fixed voltage or maintenance voltage was noted as 14.4 Volts. FIG. 7 shows float current data for the first 21 days of water loss testing for batteries (noted as “Sample #1”) containing the comparative separator as well as coated separator according to the present invention. In FIG. 7, the float current (in mA) for the coated separator loaded with a 7.4 g/m² coating of surfactant and having a serrated profile is lower than the other two, showing that that battery, relative to the other two, exhibited lower self-discharge, and/or exhibited lower water loss (lower water consumption or electrolysis). FIG. 8 shows the same type of float current data for the batteries labeled “Sample #1” for the second 21 days of water loss testing. The same phenomenon is seen in FIG. 8: the float current is lower for the separator coated with a 7.4 g/m² coating of surfactant and having a serrated profile.

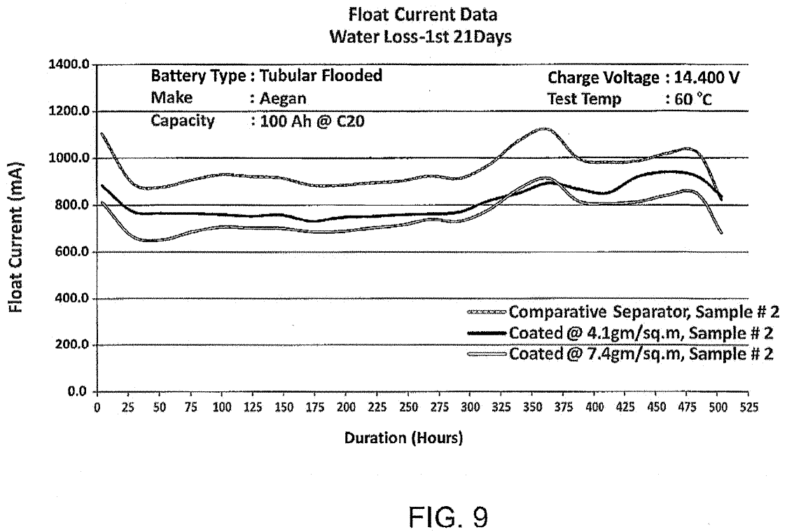

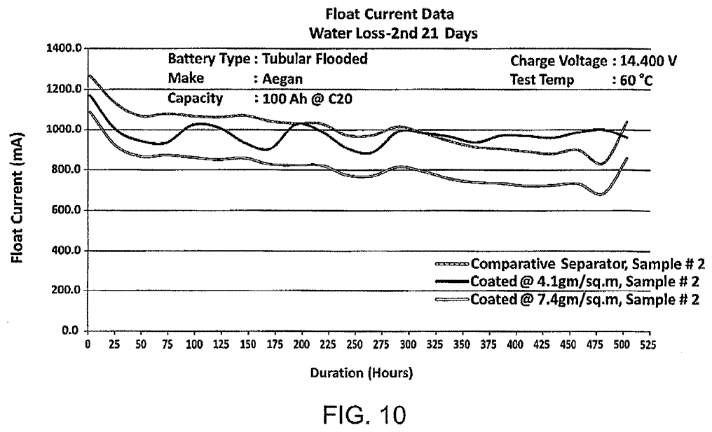

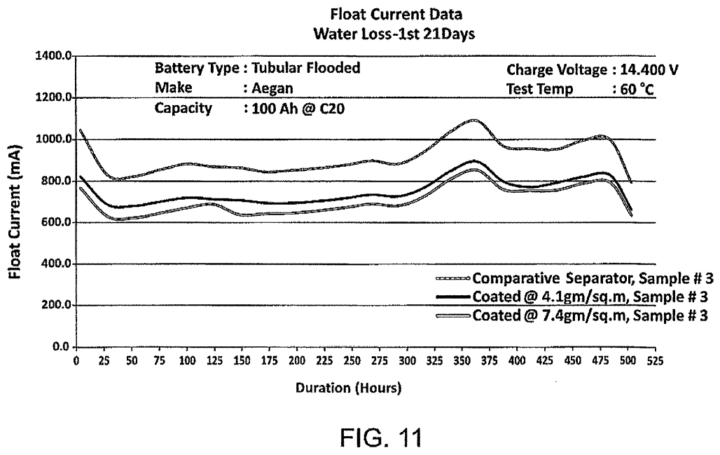

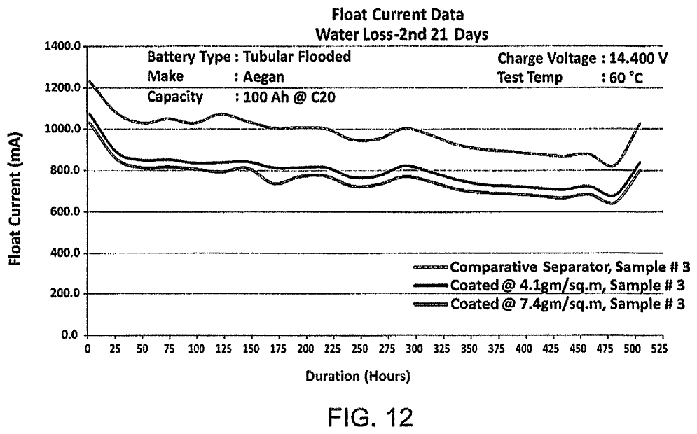

Similar to FIG. 7 and FIG. 8, FIG. 9 and FIG. 10 show the same type of data for the batteries noted as “Sample #2.” Similar to FIG. 9 and FIG. 10, FIG. 11 and FIG. 12 show the same type of data for the batteries noted “Sample #3.”

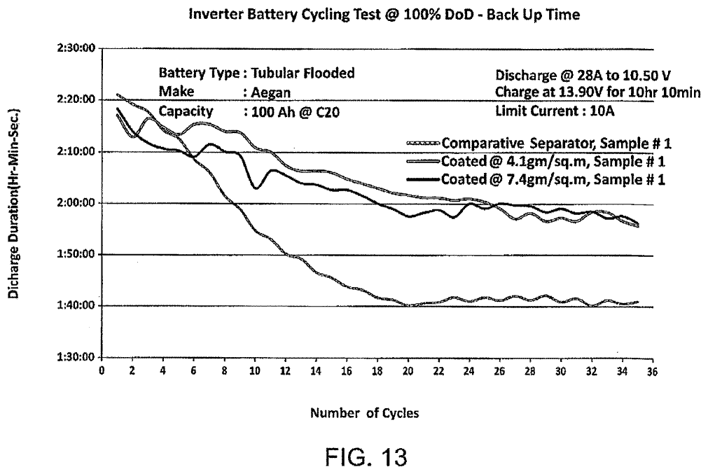

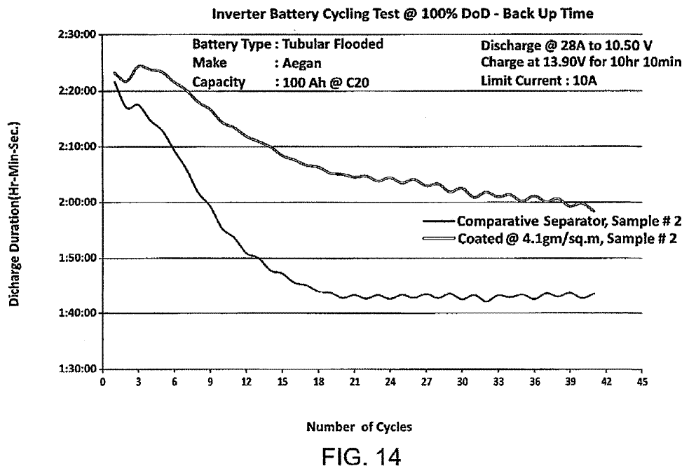

Additional testing of the batteries was performed to determine the discharge duration of the batteries as a function of the number of cycles (see FIG. 13 for example). During this testing, the 100% DoD notation stands for “100% depth of discharge,” and the batteries were tested to determine the backup time for each battery. The back-up time may refer to the amount of time during which a user can draw energy from the battery. FIGS. 13 and 14 showed that by using the separator according to the present invention, the length of time during which the battery can operate near its max capacity is extended. And by using the separator of the present invention, additional battery use time per cycle results, which is highly desirable.

The batteries in these Examples were also looked at from the perspective of specific gravity of the electrolyte. As a battery is cycled, the sulfuric acid in the electrolyte of the battery system can become stratified into layers of varying concentration. It can be important to minimize such acid stratification and to keep the specific gravity of the electrolyte consistent, which may lead to extended battery life.

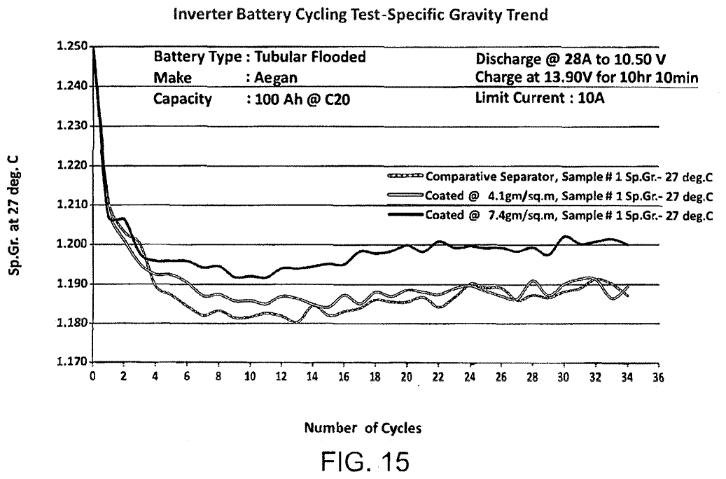

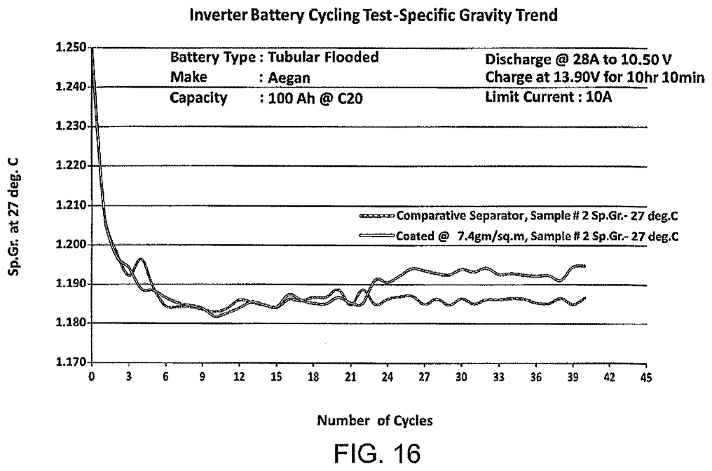

FIGS. 15 and 16 show results of battery testing done to show specific gravity trends for the electrolyte within such batteries as a number of battery cycles occurred. For both FIGS. 15 and 16, coated battery separators formed having a serrated profile showed desirable data regarding specific gravity trends.

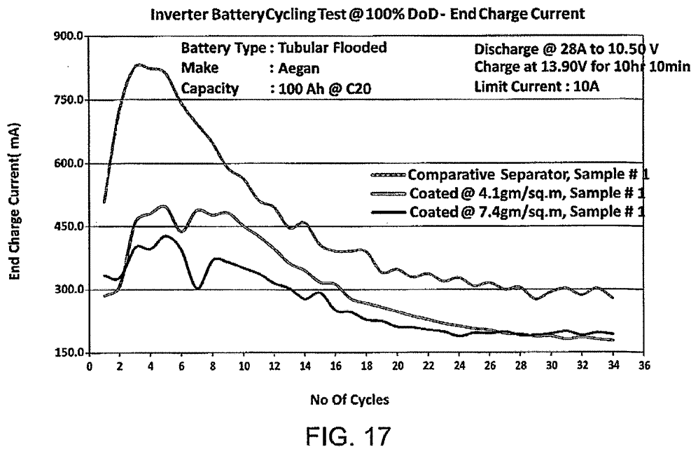

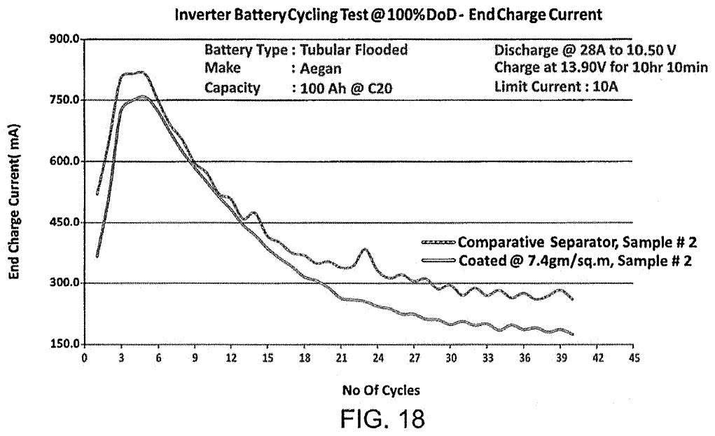

The batteries formed for these Examples were also tested for end charge current. The data for such testing is shown in FIGS. 17 and 18. The lower end charge current, for example, for the coated separator in FIG. 18 having a 7.4 g/m² coating of surfactant thereon as well as a serrated profile, represents a sign of less water loss for the batteries using the separators coated with surfactant and having a serrated profile according to the present invention.

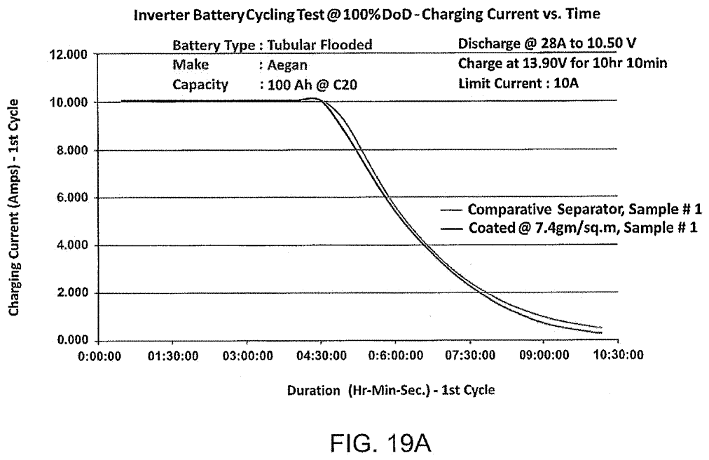

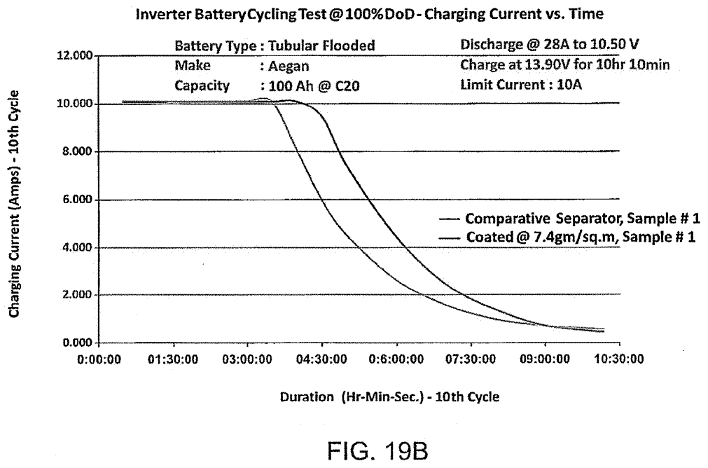

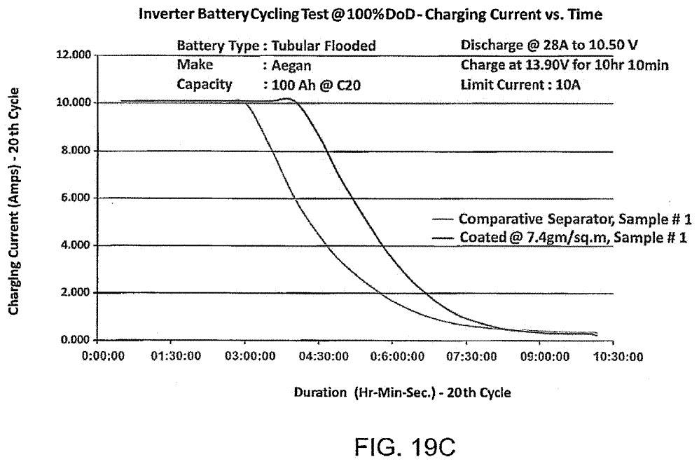

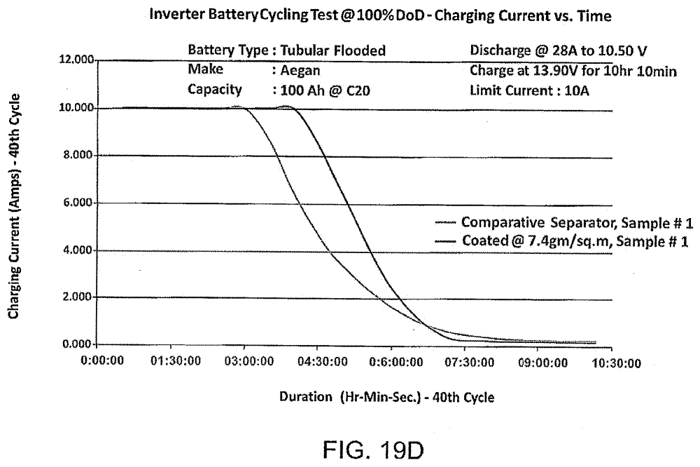

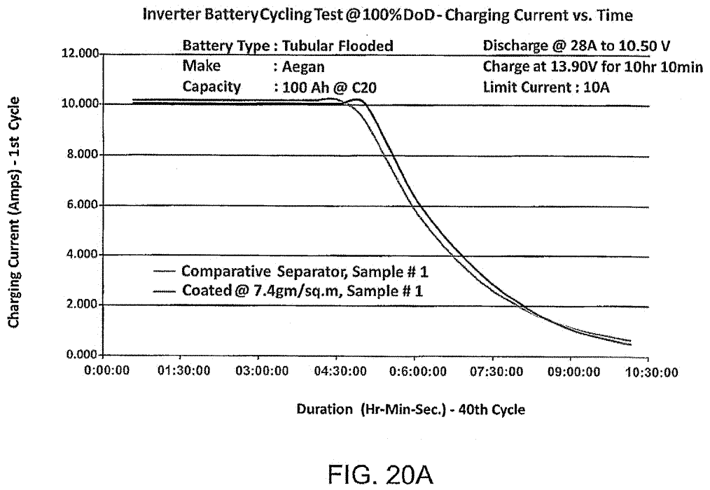

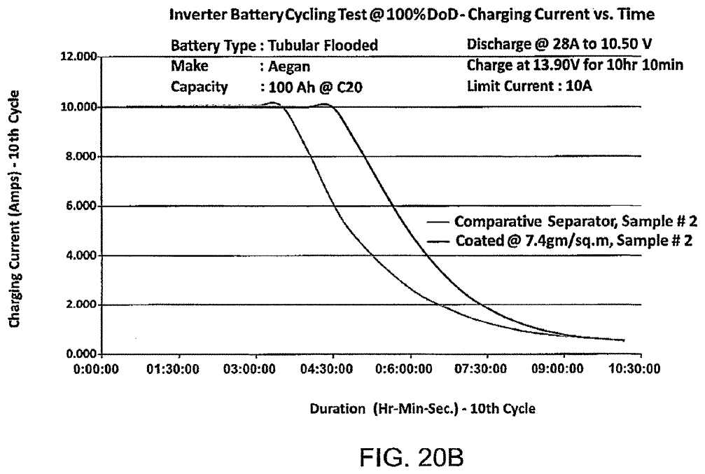

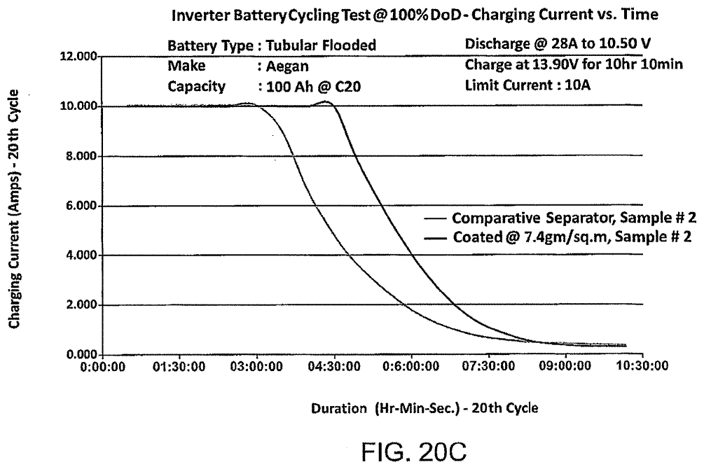

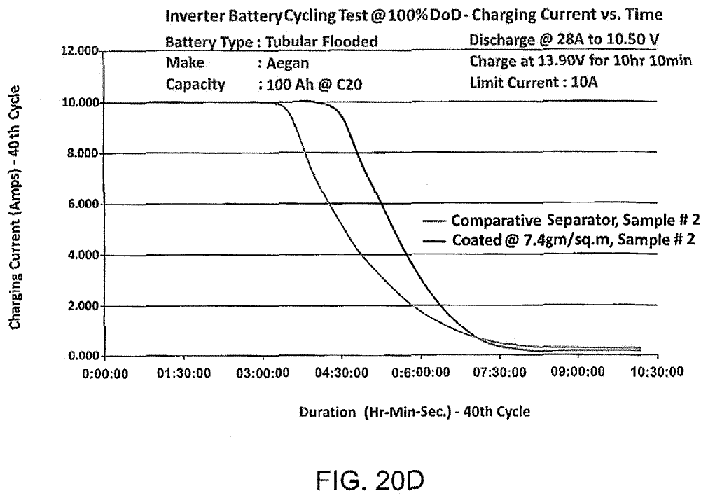

Finally, the batteries formed for these Examples were also tested to determine charging current versus duration at various cycles. Essentially, this testing helped to determine how quickly the various batteries could be recharged. The results depicted in FIGS. 19A-19D and FIGS. 20A-20D showed that batteries incorporating the coated separators according to the present invention (those having a serrated profile) were able to accept the maximum amount of charge for a longer time period. Therefore, using a battery separator according to various embodiments described herein results in retaining performance capability throughout the cycle life of the battery. Improving cycle life, retaining performance capability throughout cycle life, improving re-chargeability, improving charge acceptance, and improving (by reducing) the amount of water loss encountered by a battery are all highly desirable characteristics which may be associated with battery separators according to various embodiments presented herewith.

The instant disclosure or invention is directed to new, improved or optimized battery separators, Z wrap separators, Z wrap serrated rib separators, Z wrap serrated rib separators for tubular batteries, components, cells, modules, systems, batteries, tubular batteries, industrial batteries, inverter batteries, batteries for heavy or light industrial applications, forklift batteries, float charged batteries, inverters, accumulators, methods, profiles, additives, compositions, composites, mixes, coatings, and/or related methods of Z wrapping separators, Z wrapping separators on electrodes of tubular batteries, water retention, water loss prevention, improved charge acceptance, production, use, and/or related Z wrapping equipment, and/or combinations thereof. More particularly, the present invention is directed to one or more improved battery separators having various improvements that may result in automated separator Z wrapping, automated Z wrapped cell module production, automated tubular battery production, decreased water loss for a battery in which such a separator is incorporated, enhanced charge acceptance, or combinations thereof. Additionally, the present invention relates to one or more improved battery separators having various improvements with regard to shape, and/or physical profile, and/or chemical(s), additives, mixes, coatings, and/or the like used to make such battery separators (such as oil(s), and/or chemical additive(s) or agents used to coat, finish or improve such battery separators (such as surfactant(s))). Furthermore, the present invention relates to one or more improved separator configurations, Z wrap cell modules, Z wrap tubular electrodes, z wrap gauntlet covered tubular electrodes, and/or battery electrode and separator assembly configurations providing for automation, better acid mixing and/or reduced acid stratification over prior sleeves, pockets, or envelope separator configurations. One or more improved battery electrode and separator assembly configurations and/or manufacturing methods and/or manufacturing equipment. The improved Z wrap battery separators of the instant invention are particularly useful in or with tubular batteries, industrial batteries, such as inverter batteries, batteries for heavy or light industry, and so forth.

In accordance with certain embodiments, aspects or objects, new, improved or optimized battery separators, components, batteries, industrial batteries, inverter batteries, batteries for heavy or light industrial applications, forklift batteries, float charged batteries, tubular batteries, inverters, accumulators, systems, methods, profiles, additives, compositions, composites, mixes, coatings, and/or related methods of water retention, water loss prevention, improved charge acceptance, production, use, and/or combinations thereof may be or are provided or disclosed. More particularly, the present invention is directed to one or more improved battery separators having various improvements that may result in decreased water loss for a battery in which such a separator is incorporated, enhanced charge acceptance, or combinations thereof. Additionally, the present invention relates to one or more improved battery separators having various improvements with regard to shape, and/or physical profile, and/or chemical(s), additives, mixes, coatings, and/or the like used to make such battery separators (such as oil(s), and/or chemical additive(s) or agents used to coat, finish or improve such battery separators (such as surfactant(s))). Furthermore, inventive separator and electrode assemblies are provided with a z-shaped separator wrap about and between the electrodes. The improved battery separators of the instant invention are particularly useful in or with industrial batteries, such as inverter batteries, tubular batteries for heavy or light duty industrial applications, and so forth.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” may be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches. The present invention may be embodied in other forms without departing from the spirit and the essential attributes thereof, and, accordingly, reference should be made to the appended claims, rather than to the foregoing specification, as indicating the scope of the invention. Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

The foregoing written description of structures and methods has been presented for purposes of illustration only. Examples are used to disclose exemplary embodiments, including the best mode, and also to enable any person skilled in the art to practice the invention, including making and using any devices or systems and performing any incorporated methods. These examples are not intended to be exhaustive or to limit the invention to the precise steps and/or forms disclosed, and many modifications and variations are possible in light of the above teaching. Features described herein may be combined in any combination. Steps of a method described herein may be performed in any sequence that is physically possible. The patentable scope of the invention is defined by the appended claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

As used in the specification and the appended claims, the singular forms “a,” “an,” and “the” include plural referents unless the context clearly dictates otherwise. Ranges may be expressed herein as from “about” or “approximately” one particular value, and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. “Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers, or steps. The terms “consisting essentially of” and “consisting of” may be used in place of “comprising” and “including” to provide for more specific embodiments of the invention and are also disclosed. “Exemplary” or “for example” means “an example of” and is not intended to convey an indication of a preferred or ideal embodiment. Similarly, “such as” is not used in a restrictive sense, but for explanatory or exemplary purposes.

Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

Additionally, the invention illustratively disclosed herein suitably may be practiced in the absence of any element which is not specifically disclosed herein.

1. A lead acid battery separator adapted for a Z wrap configuration comprising:
a porous membrane comprising a first plurality of ribs on a first surface of said porous membrane, and a second plurality of ribs on a second surface of said porous membrane;
said porous membrane further comprising an amount of surfactant therein, thereon, or both, with the surfactant having an HLB value of less than or equal to approximately 6;
said porous membrane capable of folding with a radius of curvature of up to approximately 6.0 mm.

2. The lead acid battery separator of claim 1, wherein said first plurality of ribs are generally taller than said second plurality of ribs.

3. The lead acid battery separator of claim 1, wherein said first plurality of ribs are one of the following group consisting of: solid ribs, discrete broken ribs, continuous ribs, discontinuous ribs, discontinuous peaks, discontinuous protrusions, angled ribs, linear ribs, longitudinal ribs extending substantially in a machine direction of said porous membrane, lateral ribs extending substantially in a cross-machine direction of said porous membrane, transverse ribs extending substantially in said cross-machine direction of the separator, discrete teeth, toothed ribs, serrations, serrated ribs, battlements, battlemented ribs, curved ribs, sinusoidal ribs, disposed in a continuous zig-zag-sawtooth-like fashion, disposed in a broken discontinuous zig-zag-sawtooth-like fashion, grooves, channels, textured areas, embossments, dimples, columns, mini columns, porous, non-porous, mini ribs, cross-mini ribs, and combinations thereof.

4. The lead acid battery separator of claim 3, wherein at least a portion of said first plurality of ribs are defined by an angle that is neither parallel nor orthogonal relative to an edge of said separator.

5. The lead acid battery separator of claim 3, wherein said angle varies among said at least a portion of said first plurality of ribs.

6. The lead acid battery separator of claim 3, wherein at least a portion of said first plurality of ribs are defined by an angle relative to a machine direction of said porous membrane and said angle is chosen from the group consisting of: between greater than zero degrees (0°) and less than 180 degrees (180°), and greater than 180 degrees (180°) and less than 360 degrees (360°).

7. The lead acid battery separator of claim 6, wherein said angle varies among said at least a portion of said first plurality of ribs.

8. The lead acid battery separator of claim 1, wherein said second plurality of ribs are one of the following group consisting of: solid ribs, discrete broken ribs, continuous ribs, discontinuous ribs, discontinuous peaks, discontinuous protrusions, angled ribs, linear ribs, longitudinal ribs extending substantially in a machine direction of said porous membrane, lateral ribs extending substantially in a cross-machine direction of said porous membrane, transverse ribs extending substantially in said cross-machine direction of the separator, discrete teeth, toothed ribs, battlements, battlemented ribs, curved ribs, sinusoidal ribs, disposed in a continuous zig-zag-sawtooth-like fashion, disposed in a broken discontinuous zig-zag-sawtooth-like fashion, grooves, channels, textured areas, embossments, dimples, columns, mini columns, porous, non-porous, mini ribs, cross-mini ribs, and combinations thereof.

9. The lead acid battery separator of claim 1, wherein said porous membrane has a backweb thickness of approximately 150 □m to approximately 500 □m or 200 μm to approximately 500 μm.

10. The lead acid battery separator of claim 1, wherein said surfactant is at least one of not soluble in water, an aqueous solution, or sulfuric acid; fully soluble in water, an aqueous solution, or sulfuric acid; or partially soluble in water, an aqueous solution, or sulfuric acid.

11. The lead acid battery separator of claim 1, wherein said HLB value is from about 1 to about 3.

12. The lead acid battery separator of claim 1, wherein an add-on level of the surfactant is up to 10 g/m² of said porous membrane.

13. The lead acid battery separator of claim 1, wherein said polymer comprises one of the following group consisting of a polymer, polyolefin, polyethylene, polypropylene, ultra-high molecular weight polyethylene (“UHMWPE”), phenolic resin, polyvinyl chloride (“PVC”), rubber, latex, synthetic wood pulp (“SWP”), lignins, glass fibers, synthetic fibers, cellulosic fibers, and combinations thereof.

14. A lead acid battery separator and battery electrode assembly comprising said lead acid battery separator according to claim 1, and further comprising:
at least a first positive electrode, and at least a first negative electrode;
wherein said porous membrane is wrapped about said at least first positive electrode and said at least first negative electrode in a Z wrap or z-shaped fashion with a radius of curvature at a bend of up to approximately 6.0 mm;
said porous membrane being interleafed between said at least first positive electrode and said at least first negative electrode, wherein said bend is positioned on a side edge of said first positive electrode and an opposite side edge of said first negative electrode.

15. The lead acid battery separator and battery electrode assembly of claim 14, wherein said at least first positive electrode is one of either a flat plate electrode, a tubular electrode, or a gauntlet covered tubular electrode.

16. The lead acid battery separator and battery electrode assembly of claim 14, wherein said first plurality of ribs face said at least first positive electrode.

17. A lead acid battery comprising the lead acid battery separator and battery electrode assembly of claim 14; and further comprising a sulfuric acid based electrolyte.

18. The lead acid battery of claim 17, further exhibiting reduced water loss over a service life of said lead acid battery.

19. The lead acid battery of claim 17, wherein:
said porous membrane exhibits reduced oxidation damage over a service life of said lead acid battery;
said lead acid battery operates in a partial state of charge at a depth of discharge between approximately 1% and approximately 99%;
said battery operates in one of the following group consisting of in motion, stationary, in a backup power application, in a cycling applications, in a partial state of charge, and combinations thereof;
said battery is selected from the group consisting of: a tubular battery, a tubular inverter battery, flat-plate battery, a flooded lead acid battery, an enhanced flooded lead acid battery (“EFB”), a valve regulated lead acid (“VRLA”) battery, a deep-cycle battery, a gel battery, an absorptive glass mat (“AGM”) battery, a tubular battery, an inverter battery, a vehicle battery, a starting-lighting-ignition (“SLI”) vehicle battery, an idling-start-stop (“ISS”) vehicle battery, an automobile battery, a truck battery, a motorcycle battery, an all-terrain vehicle battery, a forklift battery, a golf cart battery, a hybrid-electric vehicle battery, an electric vehicle battery, an e-rickshaw battery, and an e-bike battery.

20. (canceled)

21. (canceled)

22. (canceled)

23. (canceled)

24. (canceled)

25. (canceled)

26. (canceled)

27. The lead acid battery separator according to claim 1, wherein said porous membrane is capable of folding with a radius of curvature of between approximately 1.8 mm up to approximately 6.0 mm.

28. The lead acid battery of claim 9, wherein said porous membrane has a backweb thickness of approximately 150 □m to approximately 500 □m.

29. The lead acid battery of claim 10, wherein said surfactant is not soluble, is partially soluble, or is fully soluble in water, an aqueous solution, or sulfuric acid.

30. (canceled)

31. (canceled)

32. The lead acid battery of claim 14, wherein said porous membrane is wrapped about said at least first positive electrode and said at least first negative electrode in a Z wrap or z-shaped fashion with a radius of curvature at a bend of from approximately 1.8 mm up to approximately 6.0 mm.

33. The lead acid battery of claim 14, wherein said porous membrane that is wrapped about said at least first positive electrode and said at least first negative electrode in a Z wrap or z-shaped fashion is sealed or partially sealed at the bottom.

34. The lead acid battery of claim 33, wherein the porous membrane may be sealed using at least one of staples, adhesive, heat, or other acceptable means.
